(19) United States
(12) Patent Application Publication
(10) Pub. No.: US 2018/0241096 A1
(43) Pub. Date: Aug. 23, 2018

(54) ELECTRONIC DEVICE AND METHOD THEREOF

(71) Applicant: CANON KABUSHIKI KAISHA, Tokyo (JP)

(72) Inventor: Shuya Kaechi, Hashimoto-shi (JP)

(21) Appl. No.: 15/898,574

(22) Filed: Feb. 17, 2018

(30) Foreign Application Priority Data
Feb. 17, 2017 (JP) 2017-028418

(51) Int. Cl. H01M 10/44; G06F 21/81; G06F 1/26; G06F 21/44; G08B 5/36; H02J 7/04

(52) U.S. Cl. CPC H01M 10/44; G06F 21/81; H02J 7/04; G06F 21/44; G08B 5/36; G06F 1/26

(57) ABSTRACT

An electronic device includes a load testing unit, a first control unit, and a second control unit. The load testing unit conducts a load test between a power supply apparatus and the electronic device. The first control unit stops charging of a battery pack by power supplied from the power supply apparatus during a period in which the load test is conducted. The second control unit stops outputting of an activation signal for activating the electronic device if a voltage supplied from the power supply apparatus to the electronic device falls outside a predetermined voltage range during the period in which the load test is conducted.

### BACKGROUND

### Field of the Invention

Aspects of the present invention generally relate to an electronic device capable of receiving power from an external device, and a method of controlling the external device.

### Description of the Related Art

Electronic devices using chargeable battery packs are widely used. Some electronic devices are capable of internal charging. Internal charging is a function by which an electronic device charges a battery pack while the battery pack is connected to the device. In this internal charging, a method which uses USB (Universal Serial Bus) as an interface and charges an internal battery pack of an electronic device by power obtained from a VBUS line of the USB of a power supply apparatus is widely applied. It is also possible to use power exceeding 2.5 W by establishing the standard of USB 3.0, USB BC (Battery Charging), USB PD (Power Delivery), or the like.

When charging a battery pack by power obtained from the VBUS line of a power supply apparatus connected by the USB, an electronic device must grasp the power supply capability of the power supply apparatus connected to the electronic device, and the charging/discharging characteristics of the battery pack connected to the electronic device. The electronic device determines, by performing connected device detection and an enumeration process, the power supply capability of the power supply apparatus connected to the USB, and obtains power from the VBUS line in accordance with the determined power supply capability. The electronic device can also determine whether the battery pack is suitable for the charging/discharging characteristics of the electronic device, by performing battery authentication between the device and an authentication IC of the battery pack.

Electric power is necessary to execute the determination of the power supply capability of the power supply apparatus and execute the determination of the charging/discharging characteristics of the battery pack as described above. This is so because processing must be performed by activating related hardware and software in order to perform the connected device detection, the enumeration process, the battery authentication, control of power supplied from the power supply apparatus, and charging of the battery pack.

Assume that power of 5 V and 0.5 A is necessary to normally perform the series of operations described above. When the power supply apparatus has the capability to supplying this electric power, it is possible to normally execute the abovementioned series of operations. However, if the power supply apparatus does not have the capability to supplying power of 5 V and 0.5 A, a voltage drop of the VBUS line may occur because the electronic device draws a current from the VBUS line in order to perform the above-described series of operations. As a result, the voltage of the VBUS line sometimes becomes lower than the circuit operation lower-limit voltage of the electronic device, and makes it impossible to complete the series of operations described above. If the above-described series of operations cannot be completed, it is impossible to appropriately control power reception from the power supply apparatus and charging of the battery pack. This makes it impossible to normally operate the electronic device and charge the battery pack.

Japanese Patent Laid-Open No. 2013-132185 has proposed a charging circuit including an activation designating circuit which outputs an activation signal as a trigger for the activation of an electronic device when a charging unit transits from a precharging state to a rapid charging state.

In this electronic device described in Japanese Patent Laid-Open No. 2013-132185, a threshold value when the charging unit transits from the precharging state to the rapid charging state is set as a condition capable of ensuring the execution of the abovementioned series of operations of the electronic device. This enables power source control capable of assuring the above-described series of operations. However, if the threshold value when the charging unit transits from the precharging state to the rapid charging state is set as the condition capable of guaranteeing the series of operations described above, a long time is required to charge the battery pack until the battery pack satisfies the condition. This consequently delays the activation of the electronic device and the start of rapid charging, and prolongs the time required to charge the battery pack.

### SUMMARY

According to an aspect of the present invention, there is provided an electronic device which operates by obtaining power from a power supply apparatus, and can determine whether it is possible to receive power required for the electronic device.

According to an aspect of the present invention, there is provided an electronic device comprising: a load testing unit that conducts a load test between a power supply apparatus and the electronic device; a first control unit that stops charging of a battery pack by power supplied from the power supply apparatus during a period in which the load test is conducted; and a second control unit that stops outputting of an activation signal for activating the electronic device if a voltage supplied from the power supply apparatus to the electronic device falls outside a predetermined voltage range during the period in which the load test is conducted.

According to an aspect of the present invention, there is provided a method comprising: conducting a load test between a power supply apparatus and an electronic device; stopping charging of a battery pack by power supplied from the power supply apparatus during a period in which the load test is conducted; and stopping outputting of an activation signal for activating the electronic device if a voltage supplied from the power supply apparatus to the electronic device falls outside a predetermined voltage range during the period in which the load test is conducted.

According to an aspect of the present invention, there is provided a non-transitory storage medium that stores a program causing a computer to execute a method, the method comprising: conducting a load test between a power supply apparatus and an electronic device; stopping charging of a battery pack by power supplied from the power supply apparatus during a period in which the load test is conducted; and stopping outputting of an activation signal for activating the electronic device if a voltage supplied from the power supply apparatus to the electronic device falls outside a predetermined voltage range during the period in which the load test is conducted.

Further features and aspects of the present invention will become apparent from the following description of exemplary embodiments.

### BRIEF DESCRIPTION OF THE DRAWINGS

FIGS. 1A and 1B are flowcharts for explaining an exemplary procedure of generating an activation signal of an electronic device 301 according to a first embodiment;

FIGS. 2A to 2D are timing charts for explaining timings of individual signals when generating the activation signal of the electronic device 301 according to the first embodiment;

FIGS. 3A and 3B are block diagrams for explaining exemplary arrangements of the electronic device 301 according to the first embodiment;

FIGS. 4A and 4B are flowcharts for explaining an exemplary procedure of generating an activation signal of an electronic device 301 according to a second embodiment;

FIGS. 5A to 5D are timing charts for explaining timings of individual signals when generating the activation signal of the electronic device 301 according to the second embodiment;

FIGS. 6A and 6B are block diagrams for explaining exemplary arrangements of the electronic device 301 according to the second embodiment;

FIG. 7 is a flowchart for explaining an exemplary procedure of generating an activation signal of an electronic device 301 according to a third embodiment;

FIGS. 8A to 8C are timing charts for explaining timings of individual signals when generating the activation signal of the electronic device 301 according to the third embodiment;

FIG. 9 is a block diagram for explaining an exemplary arrangement of a power source control unit 303 according to the third embodiment; and

FIG. 10 is a block diagram for explaining an exemplary arrangement of a power source control unit 303 according to a fourth embodiment.

### DESCRIPTION OF THE EMBODIMENTS

Exemplary embodiments, features, and aspects of the present invention will be described below with reference to the drawings. However, aspects of the present invention are not limited to the following exemplary embodiments.

### First Embodiment

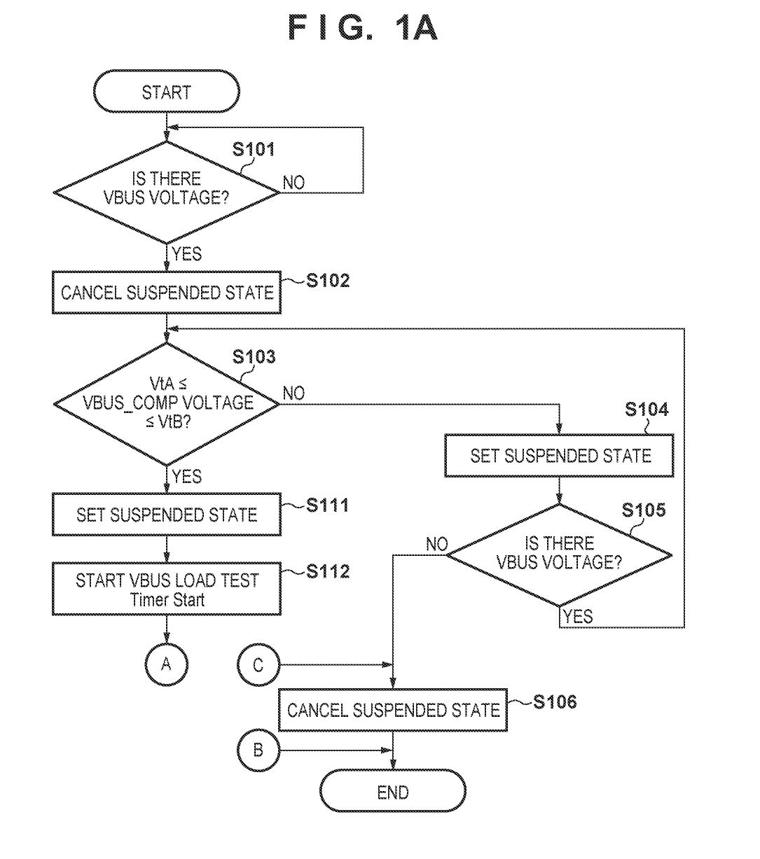

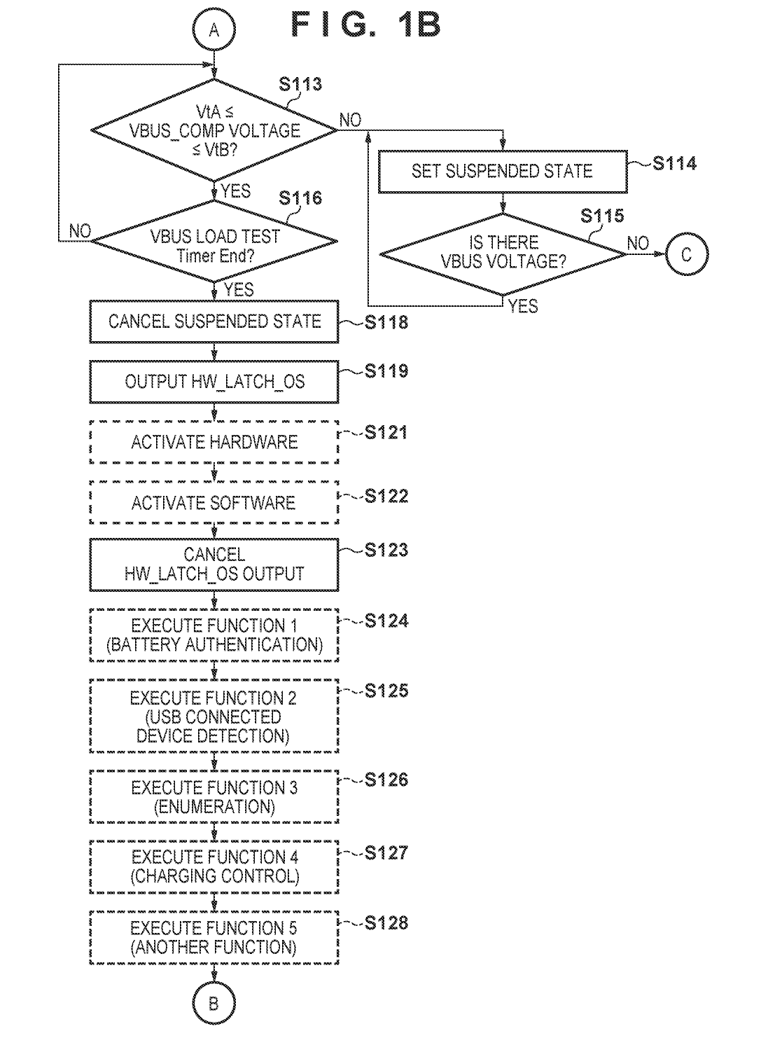

The first embodiment will be explained below with reference to FIGS. 1A, 1B, 2A to 2D, 3A, and 3B. In the first embodiment, an electronic device 301 which determines the power supply capability to a power supply apparatus 401 by conducting a VBUS load test by setting the current consumption of a VBUS line in a suspended state and generates an activation signal of the electronic device 301 in accordance with the determination result will be explained. In the first embodiment, the electronic device 301 can charge a battery pack 320 by receiving power from the power supply apparatus 401 via a USB (Universal Serial Bus) cable 404.

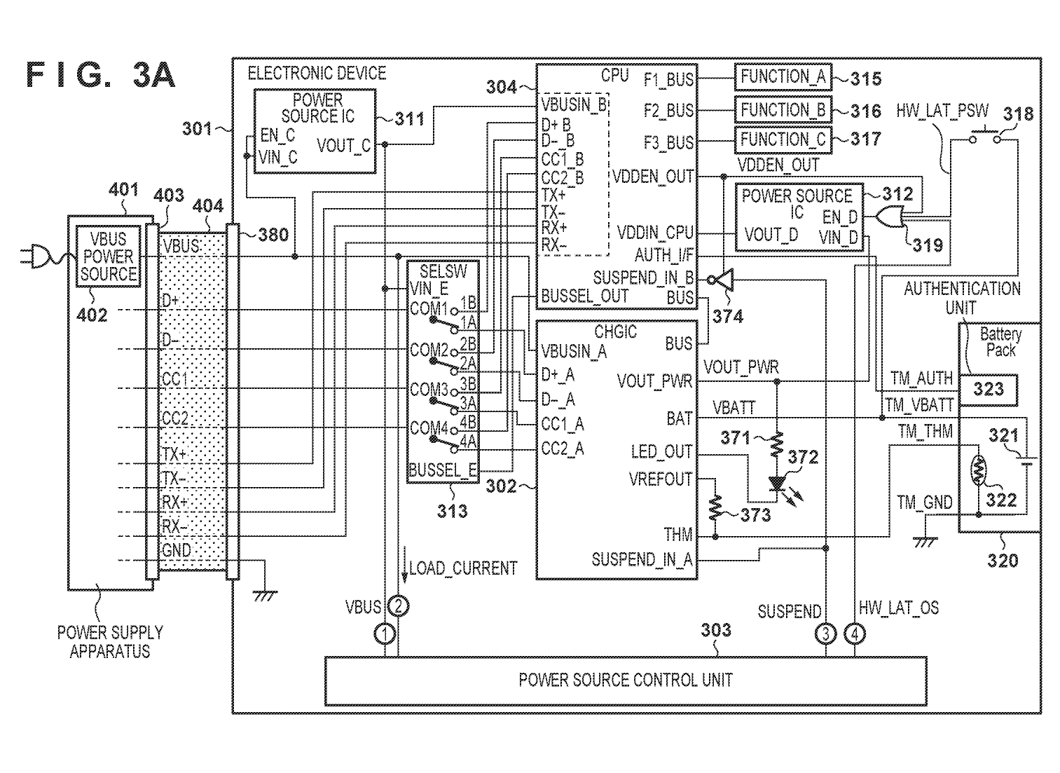

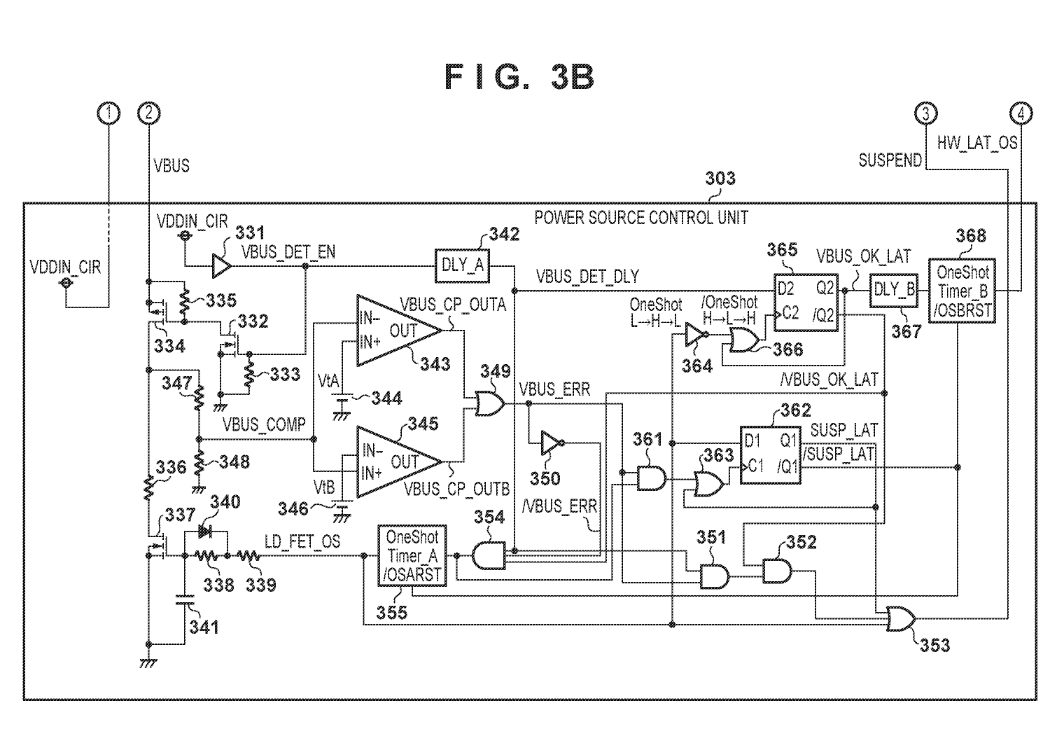

FIG. 3A is a block diagram for explaining an exemplary arrangement of the electronic device 301 according to the first embodiment. FIG. 3B is a block diagram for explaining an exemplary arrangement of a power source control unit 303 according to the first embodiment. Note that FIGS. 3A and 3B do not show power connections to constituent elements unnecessary for the explanation of the first embodiment and input and output capacitors of each constituent element. Note also that a detailed explanation of constituent elements and operations unnecessary for the explanation of the first embodiment will be omitted. Note further that in the following explanation, L indicates a signal having a logical value of 0, and H indicates a signal having a logical value of 1.

The power supply apparatus 401 is an external device capable of supplying power to the electronic device 301 via the USB cable 404. The power supply apparatus 401 can be either an apparatus capable of only power supply, or an apparatus having a function other than power supply. A VBUS power source 402 is a VBUS power source which supplies power from the power supply apparatus 401 to the electronic device 301. As power of the VBUS power source 402, it is possible to use power externally supplied to the power supply apparatus 401, or power supplied from an internal battery of the power supply apparatus 401. A USB connector 403 is a connector complying with the USB standards. The definition of the USB connector 403 will be omitted because the USB connector 403 does not restrict the apparatus configuration of the power supply apparatus 401. Also, the definition of each signal of a USB interface on the side of the power supply apparatus 401 will be omitted because the signal does not restrict the apparatus configuration of the power supply apparatus 401. The USB cable 404 connects the power supply apparatus 401 and the electronic device 301 by the USB interface. The USB standards of the USB interface can comply with any of USB 2.0, USB 3.0, USB 3.1, USB BC (Battery Charging), USB PD (Power Delivery), or USB Type-C.

The electronic device 301 can receive power from the power supply apparatus 401. A CPU 304 includes a CPU (Central Processing Unit) for controlling the electronic device 301, a RAM (Random Access Memory) to be used as a work area, and a ROM (Read Only Memory) storing programs which allow the CPU 304 to execute control procedures to be explained in the first embodiment and other embodiments. A main function of the CPU 304 operates by external voltage input received by a terminal VDDIN_CPU. Also, USB_PHY as a USB function of the CPU 304 can operate separately from the main function by external voltage input received by a terminal VBUSIN_B. The USB function of the CPU 304 is a function capable of operating with power lower than that of the main function of the CPU 304, and includes a connected device detecting function, enumeration processing function, and USB signal processing function. These functions comply with the USB standards described above.

The CPU 304 performs connected device detection by logic detection and communication of the VBUS line, a D+ line, a D− line, and a CC line. The CPU 304 can determine USB standards with which the power supply apparatus 401 complies from the results of this connected device connection. Examples of the USB standards detectable by the connected device detecting function of the CPU 304 are USB 2.0, USB 3.0, USB 3.1, USB BC, USB PD, and USB Type-C. The CPU 304 can further determine by an enumeration process with the power supply apparatus 401 connected to the electronic device 301 via the D+ and D− lines which of USB 2.0, USB 3.0, or USB 3.1 is the USB standard with which the power supply apparatus 401 complies. In the first embodiment and other embodiments, the enumeration process is a process for performing enumeration complying with the USB standard.

The CPU 304 also includes AUTH_I/F which performs a battery authentication process with respect to the battery pack 320. This battery authentication process between the CPU 304 and battery pack 320 will be described later.

Furthermore, the CPU 304 includes SUSPEND_IN_B for receiving a SUSPEND signal from the power source control unit 303. SUSPEND_IN_B receives a signal obtained by inverting the logic of a SUSPEND signal output from the power source control unit 303 by an inverter 374. The output from the inverter 374 is valid only when a VDDEN_OUT signal of the CPU 304 is output. While the CPU 304 is outputting the VDDEN_OUT signal, therefore, the inverter 374 can input a signal to SUSPEND_IN_B of the CPU 304.

A charging IC 302 is a battery charging IC capable of charging the battery pack 320. The charging IC 302 charges the battery pack 320 by receiving voltage input to VBUSIN_A. The charging IC 302 also has a function of converting a voltage input to the terminal VBUSIN_A into a constant-voltage output VOUT_PWR, and outputting this voltage to a power source IC 312. The charging IC 302 further has a function of, in a case where there is no voltage input to VBUSIN_A, outputting a voltage VBATT from the battery pack 320, which is received by BAT, to another circuit (for example, the power source IC 312) as VOUT_PWR. In addition, the charging IC 302 has the connected device detecting function like the CPU 304.

The charging IC 302 has SUSPEND_IN_A for receiving the SUSPEND signal from the power source control unit 303. If the input signal to SUSPEND_IN_A is H, the charging IC 302 restricts the VBUS input current to 2.5 mA as a USB suspend current. If the input signal to SUSPEND_IN_A is L, the charging IC 302 cancels the suspended state, and restricts the VBUS input current to a value other than the abovementioned SUSPEND current. In each embodiment, a state in which the charging IC 302 restricts the VBUS input current to 2.5 mA as a SUSPEND current will be called a suspended state. In the suspended state in which the SUSPEND signal input is H, the charging IC 302 inhibits charging of the battery pack 320 by the charging IC 302. On the other hand, if the SUSPEND signal input is L, the charging IC 302 sets VBUS input current restriction in accordance with the USB standards with which the power supply apparatus 401 complies.

Also, the charging IC 302 is connected to the CPU 304 by a BUS. By communication using the BUS, the CPU 304 acquires the state of the charging IC 302, acquires the state of the battery pack 320, and performs register control of the charging IC 302.

The battery pack 320 is detachable from the electronic device 301, and includes a battery cell 321 using, for example, a lithium-ion battery, a thermistor 322, and an authentication unit 323. The output (VBATT) from the battery cell 321 is supplied to BAT of the charging IC 302 and a button switch 318. The thermistor 322 has, for example, the characteristic of NTC (Negative Temperature Coefficient). The authentication unit 323 guarantees that the battery is a specially designed battery suited to the charging characteristic. The battery pack 320 is connected to the electronic device 301 via four terminals, that is, a voltage output terminal TM_VBATT, thermistor terminal TM_THM, ground terminal TM_GND, and authentication terminal TM RUTH. The thermistor terminal TM_THM is connected to the THM terminal of the charging IC 302, and pulled up to a voltage output VREFOUT of the charging IC 302 by a pull-up resistor (a PU resistor 373).

The CPU 304 connects to the authentication unit 323 of the battery pack 320 by AUTH_I/F, and performs battery authentication with respect to the authentication unit 323. If battery authentication is normally performed, the CPU 304 performs control such that the charging IC 302 charges the battery pack 320 by a current suitable for the charging characteristic of the battery pack 320. If battery authentication is not normally performed, the CPU 304 stops charging of the battery pack 320 by the charging IC 302 for safety's sake. Note that in the first embodiment, if the electronic device 301 cannot normally perform battery authentication, charging of the battery pack 320 by the charging IC 302 is stopped for safety. However, the present invention is not limited to this. For example, if the electronic device 301 cannot normally perform battery authentication, it is also possible to perform charging by limiting the charging current of the battery pack 320 to a sufficiently small value for safety's sake.

A power source IC 311 receives an external voltage input to VIN_C, converts the input voltage into a constant-voltage output, and outputs the constant voltage from VOUT_C to the CPU 304 and power source control unit 303. A signal input to EN C of the power source IC 311 controls ON/OFF of the output from VOUT_C. The power source IC 312 receives an external voltage input to a terminal VIN_D, converts the input voltage into a constant-voltage output, and outputs the constant voltage from VOUT_D to VDDIN_CPU of the CPU 304. A signal input to EN D of the power source IC 312 controls ON/OFF of the output from VOUT_D.

A selector switch 313 switches the transmission destination of a signal to be used in connected device detection to one of the CPU 304 and charging IC 302. The connections of the selector switch 313 can be switched by a signal input to BUSSEL_IN. In the initial state of the selector switch 313, the signal to be used in connected device detection is connected to the charging IC 302, so the charging IC 302 performs connected device detection. Note that the CPU 304 can also perform connected device detection. In the initial state, therefore, it is also possible to connect the signal to be used in connected device detection to the CPU 304, and perform connected device detection by the CPU 304.

A USB connector 380 is a connector complying with the USB Type-C standard. FUNCTION_A 315 to FUNCTION_C 317 are constituent elements which implement predetermined functions. For example, these constituent elements are as follows when the electronic device 301 is an image capture apparatus (for example, a digital camera). The FUNCTION_A 315 is an image capture unit which generates digital image data from a signal obtained by an image capture element. The FUNCTION_B 316 is a recording control unit which controls write to a recording medium (for example, a flash memory card) for the digital image data obtained from the image capture unit, and controls read of the digital image data stored in the recording medium. The FUNCTION_C 317 is a display control unit which displays information concerning the electronic device 301 on a display device (for example, a liquid crystal display), and displays the digital image data obtained from the image capture unit or recording control unit. The electronic device 301 is, of course, not limited to an image capture apparatus, and the FUNCTION_A 315, FUNCTION_B 316, and FUNCTION_C 317 are not limited to the above elements either. For example, the electronic device 301 may also be a portable terminal such as a cell phone.

The button switch 318 is a power button switch for turning on the power source IC 312, thereby starting the operation of the main function of the CPU 304. When the button switch 318 is pressed, a VBATT signal and HW_LAT_PSW signal are turned on. That is, the button switch 318 outputs the HW_LAT_PSW signal to another circuit when pressed.

The HW_LAT_PSW signal from the button switch 318, the VDDEN_OUT signal from the CPU 304, and an HW_LAT_OS signal from the power source control unit 303 are input to an OR 319. The output of the OR 319 is connected to EN D of the power source IC 312. Therefore, the power source IC 312 is turned on when one of the HW_LAT_PSW signal, HW_LAT_OS signal, and VDDEN_OUT signal is input. In the first embodiment, the HW_LAT_PSW signal, HW_LAT_OS signal, and VDDEN_OUT signal are generically called activation signals.

The anode of an LED (Light Emitting Diode) 372 is connected to VOUT_PWR of the charging IC 302 via a resistor 371. The cathode of the LED 372 is connected to LED_OUT of the charging IC 302. LED_OUT of the charging IC 302 is an open collector or open drain output, and the output from LED_OUT controls ON/OFF of the LED 372. The LED 372 functions as a display device displaying the state of charging of the battery pack 320 by the charging IC 302. For example, the LED 372 is kept ON while the charging IC 302 is charging the battery pack 320, and kept OFF while the charging IC 302 is not charging the battery pack 320.

The power source control unit 303 determines the power supply capability of the power supply apparatus 401 by conducting a VBUS load test as a load test for the VBUS line, and controls the activation of the electronic device 301 and the suspended state of the charging IC 302. The power source control unit 303 obtains power through VDDIN_CIR from VOUT_C of the power source IC 311. Accordingly, power is always supplied to the power source control unit 303 while the VBUS of the power supply apparatus 401 is connected and power is supplied. When power supply is started from a state in which power is not supplied through VDDIN_CIR, the logic of each circuit of the power source control unit 303 is initialized, and the function is negated. Also, when power supply is terminated from a state in which power is supplied through VDDIN_CIR, the function of each circuit of the power source control unit 303 is negated. Note that an explanation of the transitional state of each circuit unnecessary for the explanation of the first embodiment will be omitted.

A buffer 331 outputs a signal (VBUS_DET_EN) to an Nch MOSFET 332 and a DLY_A 342 without inverting the logic of VDDIN_CIR. The VBUS_DET_EN signal is connected to the gate of the Nch MOSFET 332, and controls ON/OFF of the Nch MOSFET 332. A resistor 333 is a pull-down resistor between the source/gate and GND. Note that the Nch MOSFET 332 is not limited to an Nch MOSFET, and can be any element, such as an NPN transistor, which is electrically connected when turned on and increases the impedance when turned off.

The drain of the Nch MOSFET 332 is connected to a Pch MOSFET 334. ON/OFF of the Nch MOSFET 332 controls ON/OFF of the Pch MOSFET 334. A resistor 335 is a pull-up resistor between the source/gate and VBUS. Note that the Pch MOSFET 334 is not limited to a Pch MOSFET, and can be any element, such as a PNP transistor, which is electrically connected when turned on and increases the impedance when turned off.

The drain of the Pch MOSFET 334 is connected to the drain of an Nch MOSFET 337 via a register 336. The drain of the Pch MOSFET 334 is connected to GND via resistors 347 and 348. When the Pch MOSFET 334 is ON, the VBUS voltage is divided by the resistors 347 and 348 via the Pch MOSFET 334. This VBUS-voltage signal (VBUS_COMP) divided by the resistors 347 and 348 is input to comparators 343 and 345.

The source of the Nch MOSFET 337 is connected to GND. The output (LD_FET_OS) of a one-shot timer 355 is connected to the gate of the Nch MOSFET 337 via resistors 338 and 339. A diode 340 and a capacitor 341 are also connected to the gate of the Nch MOSFET 337. The LD_FET_OS signal controls ON/OFF of the Nch MOSFET 337.

When both the Pch MOSFET 334 and Nch MOSFET 337 are ON, a load testing current (LOAD_CURRENT) flows through the VBUS line. When the LD_FET_OS signal transits from L to H, the capacitor 341 is charged via the resistors 338 and 339, so the gate voltage of the Nch MOSFET 337 gradually rises, and LOAD_CURRENT also gradually rises. When the LD_FET_OS signal transits from H to L, the capacitor 341 is discharged via the diode 340 and resistor 339, so the gate voltage of the Nch MOSFET 337 rapidly decreases, and LOAD_CURRENT rapidly reduces to OFF. That is, the LD_FET_OS signal performs control such that the current gradually changes when LOAD_CURRENT transits from OFF to ON, and rapidly changes when LOAD_CURRENT transits from ON to OFF.

Since the current gradually changes when LOAD_CURRENT transits from OFF to ON, the influence of a transient response caused by the current change of the VBUS power source 402 of the power supply apparatus 401 reduces, so an effect of implementing the VBUS load test by a steady current is obtained. Also, since the current rapidly changes when LOAD_CURRENT transits from ON to OFF, the load testing current can immediately be turned off if the VBUS voltage decreases to a predetermined value during the VBUS load test. This makes it possible to obtain an effect of preventing a situation in which the VBUS voltage becomes lower than the circuit operation lower-limit voltage of the power source IC 311 or charging IC 302 during the VBUS load test, and the power source IC 311 or charging IC 302 is reset.

A reference voltage VtA 344 is connected to the VIN+ input of the comparator 343, and the VBUS_COMP signal is connected to the VIN− input of the comparator 343. In the first embodiment, the value of the reference voltage VtA 344 is defined as 4.1 V, as a value of, for example, the VBUS voltage, which is Charging Port Undershoot Voltage defined by the USB BC standard. Note that the value of the reference voltage VtA 344 is not limited to the above value, and the reference voltage VtA 344 can also be defined in accordance with the power supply capability complying with the USB standards with which the electronic device 301 complies. However, the value of the reference voltage VtA 344 is desirably so defined that even when a VBUS voltage drop occurs due to the VBUS load test, the VBUS voltage does not become lower than the circuit operation lower-limit voltage of the power source IC 311 or charging IC 302.

The comparator 343 compares the VIN+ input and VIN− input, outputs H when the VIN+ input signal is larger, and outputs L when the VIN− input is larger. The output (VBUS_CP_OUTA) of the comparator 343 is connected to the input of an OR 349.

The VBUS_COMP signal is connected to the VIN+ input of the comparator 345, and a reference voltage VtB 346 is connected to the VIN− input of the comparator 345. In the first embodiment, the value of the reference voltage VtB 346 is defined as 6.0 V, as a value of, e.g., the VBUS voltage, which is Charging Port Overshoot Voltage defined by the USB BC standard. Note that the value of the reference voltage VtB 346 is not limited to the above value, and the reference voltage VtB 346 can also be defined in accordance with the power supply capability complying with the USB standards with which the electronic device 301 complies. However, the value of the reference voltage VtB 346 is desirably so defined that when LOAD_CURRENT of the VBUS load test flows through the resistor 336, the current amount and time do not exceed the current rating of the resistor 336.

The comparator 345 compares the VIN+ input and VIN− input, outputs H when the VIN+ input is larger, and outputs L when the VIN− input is larger. The output (VBUS_CP_OUTB) of the comparator 345 is connected to the input of the OR 349. The comparators 343 and 345 monitor whether the VBUS voltage falls within a predetermined voltage range between VtA (inclusive) and VtB (inclusive). If the VBUS voltage falls outside the predetermined voltage range, that is, if the VBUS voltage is lower than VtA or higher than VtB, the VBUS_CP_OUTA signal or VBUS_CP_OUTB signal changes to H, and a VBUS_ERR signal changes to H.

A DLY_A 342 is a delay circuit which delays an input by a predetermined time (time: TdlyA), and outputs the signal. The output (VBUS_DET_DLY) of the DLY_A 342 is connected to the inputs of ANDs 351 and 354, and the D2 input of a D-FF 365. The delay time TdlyA of the DLY_A 342 is a time for waiting for VBUS_COMP, which is compared by the comparators 343 and 345, to stabilize since the Pch MOSFET 334 is turned on by VBUS_DET_EN.

The output (VBUS_ERR) of the OR 349, to which the VBUS_CP_OUTA signal and VBUS_CP_OUTB signal are input, is connected to the inputs of an inverter 350, an AND 361, and the AND 351. The VBUS_ERR signal is a signal which changes to H when the VBUS load test causes the VBUS voltage to exceed the lower limit and upper limit defined by the electronic device 301, thereby representing an error of the VBUS voltage.

The output (/VBUS_ERR) of the inverter 350 which inverts the VBUS_ERR signal is connected to the AND 354. The output of the AND 351 to which the VBUS_DET_DLY signal and VBUS_ERR signal are input is connected together with a/VBUS_OK_LAT signal to the input of an AND 352. The output of the AND 352 is connected to the input of an OR 353.

The output (SUSPEND) of the OR 353 is connected to SUSPEND_IN_A of the charging IC 302, and also connected to SUSPEND_IN_B of the CPU 304 via the inverter 374.

The VBUS_DET_DLY signal, /VBUS_ERR signal, and/VBUS_OK_LAT signal are connected to the input of the AND 354, and the output of the AND 354 is connected to the one-shot timer 355 and AND 361. The AND 354 outputs H when the VBUS_DET_DLY signal transits from L to H, the/VBUS_OK_LAT signal indicating that the VBUS load test is not complete is H, and the/VBUS_ERR signal indicating that the VBUS voltage has no error is H.

The one-shot timer 355 outputs a signal H during a one-shot timer time (time: TosA) by using the L-to-H leading edge of the input signal (the output from the AND 354) as a trigger. During TosA, even when the leading edge is input to the one-shot timer 355 again, the one-shot timer 355 ignores it. The one-shot timer 355 outputs a signal L when/OSARST (a reset input) is L regardless of whether the timing is in the TosA period. A/SUSPEND_LAT signal is connected to /OSARST of the one-shot timer 355. The output (LD_FET_OS) of the one-shot timer 355 is connected to the inputs of the resistor 339 and OR 353, D1 of a D-FF 362, and an inverter 364.

The Nch MOSFET 337 is turned on when the LD_FET_OS signal is H, and turned off when the LD_FET_OS signal is L. An operation of controlling ON/OFF of the Nch MOSFET 337 by delaying a gate voltage generated by the LD_FET_OS signal is the same as described above.

The value and time of LOAD_CURRENT are mainly set by the resistance value of the resistor 336 and the time of TosA. In the first embodiment, the value and time of LOAD_CURRENT are so set as to realize 500 mA and 2 ms. However, the value and time of LOAD_CURRENT are not limited to the above setting. However, the value and time of LOAD_CURRENT are desirably set to a combination of a current and time capable of discharging at least a charge amount obtained by a maximum voltage of 5.25 V as the DC characteristic of VBUS defined by the USB 2.0 standard, and a decoupling capacitor minimum capacitance of 120 μF.

The VBUS_ERR signal and the output of the AND 354 are connected to the input of the AND 361, and the output of the AND 361 is connected to an OR 363. The output of the OR 363 is connected to the CLK1 input of the D-FF 362. The Q1 output (SUSP_LAT) of the D-FF 362 is connected to the inputs of the ORs 363 and 353. Also, the /Q1 output (/SUSP_LAT) of the D-FF 362 is connected to the/OSARST input of the one-shot timer 355, and the/OSBRST input of the one-shot timer 368.

When the CLK1 input of the D-FF 362 transits from L to H during a period in which the D1 input is H, the Q1 output is latched to H, and the /Q1 output is latched to L. Accordingly, when the VBUS_ERR signal transits from L to H during a period in which the LD_FET_OS signal is H, the D-FF 362 latches the Q1 output (SUSP_LAT) to H, and the /Q2 output (/SUSP_LAT) to L. Also, when the Q1 output of the D-FF 362 is latched to H, the CLK1 input (the output of the OR 363) is fixed to H, so the states of the Q1 output and /Q1 output of the D-FF 362 remain unchanged even if the state of the VBUS_ERR signal changes after that. That is, the D-FF 362 latches an error signal H of the VBUS voltage generated when the VBUS voltage exceeds the defined lower limit and upper limit of the voltage during the VBUS load test period, and ignores the state transition of the error signal of the VBUS voltage in other periods.

When latched to H by the generation of the VBUS-voltage error signal, the SUSP_LAT signal of the D-FF 362 is output as a SUSPEND signal to the charging IC 302 and CPU 304 via the OR 353. The charging IC 302 is set in a SUSPEND state when the SUSPEND signal is input to SUSPEND_IN_A. Also, an inverted signal of H of the SUSPEND signal is input to SUSPEND_IN_B of the CPU 304 via the inverter 374. Consequently, the CPU 304 detects that the power source control unit 303 is outputting the SUSPEND signal, and the charging IC 302 is in the SUSPEND state.

In the first embodiment, the SUSPEND signal as the output from the OR 353 changes to H under one of the following conditions:

(1) The VBUS load test is being conducted, that is, the LD_FET_OS signal is H during the during the TosA period of the one-shot timer 355.

(2) The VBUS_ERR signal as an error signal of the VBUS signal transits from L to H and the SUSP_LAT signal is latched to H during the VBUS load test.

(3) The VBUS_ERR signal as an error signal of the VBUS voltage is H after the VBUS_DET_DLY signal transits from L to H with a delay of TdlyA since VDDIN_CIR is turned on, and before the VBUS load test.

The/SUSP_LAT signal of the D-FF 362 is latched to L by the VBUS_ERR signal, and latches the outputs of the one-shot timer 355 and a one-shot timer 368 to L. The LD_FET_OS signal is connected to the input of the inverter 364, and the output of the inverter 364 is connected to an OR 366. The output of the OR 366 is connected to the CLK2 input of the D-FF 365. The Q2 output (VBUS_OK_LAT) of the D-FF 365 is connected to the input of the OR 366 and the input of a DLY_B 367. The /Q1 output (/VBUS_OK_LAT) of the D-FF 365 is connected to the inputs of the ANDs 352 and 354.

The D2 input of the D-FF 365 transits from L to H by the VBUS_DET_DLY signal which transits from L to H with a delay of TdlyA since VDDIN_CIR is turned on. When the LD_FET_OS signal transits like L→H→L while the D2 input of the D-FF 365 is H, the CLK2 input transits like H→L→H, so the Q2 output is latched to H, and the /Q2 output is latched to L. When the Q2 output of the D-FF 365 is latched to H, the CLK2 input is fixed to H, so the state of the /Q2 output of the D-FF 365 remains unchanged even when the state of the LD_FET_OS signal changes after that. That is, the D-FF 365 latches the H-to-L state transition of the LD_FET_OS signal generated when the VBUS load test is started and terminated by logically inverting the state transition, and does not latch the state transition of the LD_FET_OS signal in other periods.

The VBUS_OK_LAT signal of the D-FF 365 is latched to H by the H-to-L state transition of the LD_FET_OS signal when the started VBUS load test is complete. The DLY_B 367 delays an input for a predetermined time (time: TdlyB) and outputs the signal. The output of the DLY_B 367 is connected to the input of the one-shot timer 368. The delay time TdlyB of the DLY_B 367 is a time which satisfies the time during which the LOAD_CURRENT transits from ON to OFF under the control of the LD_FET_OS signal.

The one-shot timer 368 outputs a signal H for only a one-shot timer time (time: TosB) by using the L-to-H leading edge of the input as a trigger. Even when the leading edge is input again during TosB, the input edge is ignored. The /SUSP_LAT signal is connected to the /OSBRST input of the one-shot timer 368. When the /OSBRST input as a reset input is L, the one-shot timer 368 ignores the leading edge of an input and outputs a signal L regardless of whether the timing is in the period of TosB. Also, the output of the one-shot timer 368 is latched to L if an error occurs (/SUSP_LAT) in the VBUS voltage.

The output (HW_LAT_OS) of the one-shot timer 368 functions as an activation signal for turning on the power source IC 312 via the OR 319. The one-shot timer time TosB is a time which satisfies the activation time of hardware and software necessary to turn on the power source IC 312 by the HW_LAT_OS signal and activate the CPU 304 of the electronic device 301.

When the hardware and software of the CPU 304 are normally activated, the CPU 304 outputs H to the VDDEN_OUT signal before the TosB time elapses. In the electronic device 301, therefore, the activated state is maintained even when the HW_LAT_OS signal from the power source control unit 303 transits from H to L after the elapse of the TosB time. Note that if the hardware and software are not normally activated due to some trouble, the HW_LAT_OS signal from the power source control unit 303 transits from H to L after the elapse of the TosB time, so the output VOUT_D of the power source IC 312 stops. This makes it possible to prevent, without controlling the software, a situation in which the VOUT_D output of the power source IC 312 continues, so safe power source control can be performed.

Next, an exemplary procedure for generating an activation signal of the electronic device 301 by conducting the VBUS load test will be explained with reference to flowcharts shown in FIGS. 1A and 1B. Note that the flowcharts of FIGS. 1A and 1B show processes to be performed by the power source control unit 303, and show processes to be performed by units other than the power source control unit 303 by the broken lines.

When the VBUS voltage is supplied to VDDIN_CIR, the power source control unit 303 outputs L to the SUSPEND signal for at least the period of TdlyA, thereby canceling the suspended state of the charging IC 302 (steps S101 and S102). The VBUS power of the power supply apparatus 401 is supplied to VIN_C of the power source IC 311, and VOUT_C of the power source IC 311 outputs a constant voltage. When this constant voltage output from VOUT_C is supplied to VDDIN_CIR of the power source control unit 303, the power source control unit 303 starts operating. By delaying the transition to H of the output signal from the buffer 331 by the delay time TdlyA of the DLY_A342, L is output to the SUSPEND signal for at least the period of TdlyA. Note that if the VBUS voltage is insufficient and the power source control unit 303 cannot operate, step S101 is repeated, and the power source control unit 303 waits until the VBUS voltage is supplied.

After the elapse of the time TdlyA, the power source control unit 303 determines whether the VBUS_COMP voltage falls within the predetermined voltage range between VtA (inclusive) and VtB (inclusive) (VtA<VtB) (step S103). If it is determined that the VBUS_COMP voltage falls outside the predetermined voltage range between VtA (inclusive) and VtB (inclusive), the power source control unit 303 changes the SUSPEND signal to H, thereby suspending the charging IC 302 (NO in step S103, and step S104). Then, the power source control unit 303 repeats returns step S103 while the VBUS voltage is supplied (YES in step S105). On the other hand, if the supply of the VBUS voltage is stopped, the power source control unit 303 cancels the suspended state of the charging IC 302 by changing the SUSPEND signal to L, thereby terminating processes shown in the flowchart of FIG. 1A (NO in step S105, and step S106). Thus, the execution of the VBUS load test is inhibited if the voltage supplied from the power supply apparatus 401 falls outside the predetermined voltage range between VtA (inclusive) and VtB (inclusive) before the execution of the VBUS load test.

If it is determined in step S103 that the VBUS_COMP voltage falls within the predetermined voltage range between VtA (inclusive) and VtB (inclusive), the power source control unit 303 changes the SUSPEND signal to H, thereby suspending the charging IC 302 (YES in step S103, and step S111). Then, the power source control unit 303 starts the VBUS load test (step S112). That is, when the output of the AND 354 transits to H, the one-shot timer 355 changes the LD_FET_OS signal to H on this leading edge, thereby starting the one-shot timer time TosA of the VBUS load test. When the LD_FET_OS signal changes to H, the Nch MOSFET 337 is turned on, and the load testing current from the VBUS line flows through the Nch MOSFET 337.

When the VBUS load test is started, the power source control unit 303 draws the load testing current from the power supply apparatus 401 and monitors the VBUS voltage as a voltage supplied from the power supply apparatus 401 during the VBUS load test (steps S113 and S116). The power source control unit 303 determines whether the VBUS_COMP voltage falls within the predetermined voltage range between VtA (inclusive) and VtB (inclusive) (step S113). If it is determined that the VBUS_COMP voltage falls outside the predetermined voltage range between VtA (inclusive) and VtB (inclusive) (NO in step S113), the power source control unit 303 maintains the output state of the SUSPEND signal output in step S111 (step S114), thereby maintaining the suspended state of the charging IC 302. Also, the power source control unit 303 terminates the VBUS load test even when the one-shot timer time TosA started in step S112 has not elapsed. Then, the power source control unit 303 maintains this state while the VBUS voltage is supplied (YES in step S115). If the supply of the VBUS voltage stops (NO in step S115), the power source control unit 303 executes the process of step S106 described above.

If the state in which the VBUS_COMP voltage is falls within the predetermined voltage range between VtA (inclusive) and VtB (inclusive) is maintained for the time TosA (YES in step S113, and YES in step S116), the power source control unit 303 determines that the result of the VBUS load test is successful. If the VBUS load test is successful, the power source control unit 303 outputs L to the SUSPEND signal, thereby canceling the suspended state of the charging IC 302 (step S118). Then, the power source control unit 303 outputs H to the HW_LAT_OS signal after the elapse of TdlyB as the delay time of the DLY_B 367 (step S119), and returns the signal to L after the elapse of the time TosB (step S123).

When the HW_LAT_OS signal (an activation signal) changes to H, the power source IC 312 is turned on, and the CPU 304 of the electronic device 301 is activated. The activated CPU 304 activates the hardware (step S121), and activates the software (step S122). After that, in steps S124 to S128, the CPU 304 performs the battery authentication process with the battery pack 320, connected device detection, the enumeration process with the power supply apparatus 401, charging of the battery pack 320, and the like. Note that the processes to be performed in steps S124 to S128 by the CPU 304 are not limited to the above processes. As described above, when the state in which the VBUS voltage falls within the predetermined voltage range between VtA (inclusive) and VtB (inclusive) is maintained during the period of the VBUS load test, an activation signal for activating the electronic device 301 is generated. On the other hand, if the VBUS voltage cannot maintain the predetermined voltage range during the period of the VBUS load test, the generation of the activation signal is inhibited.

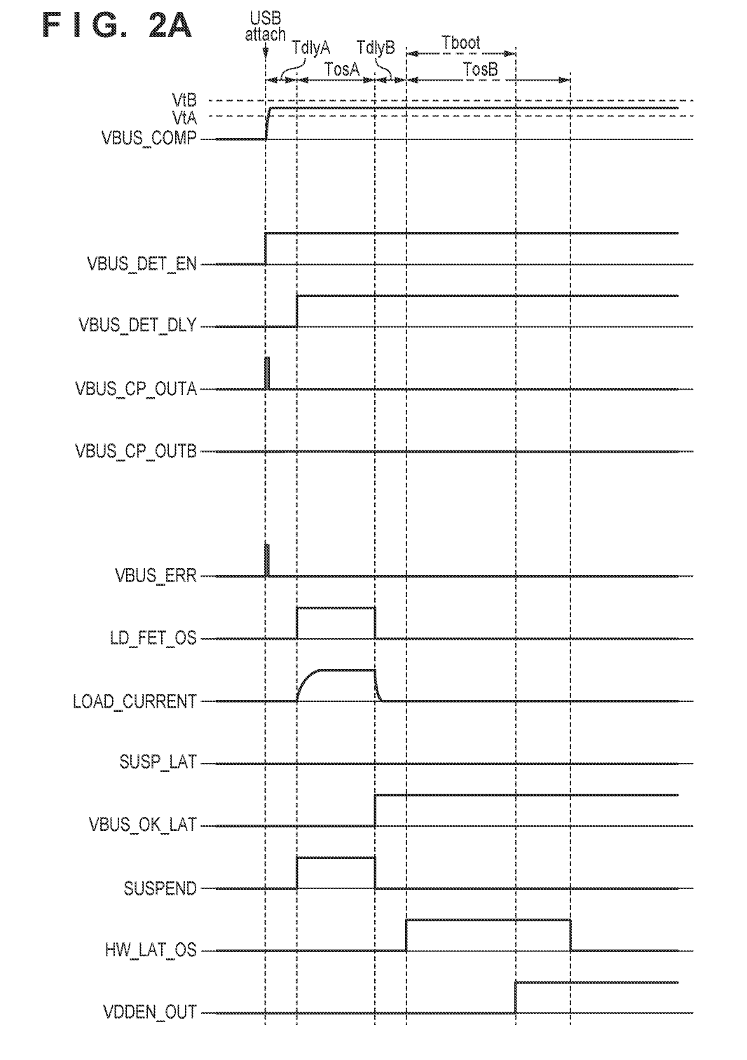

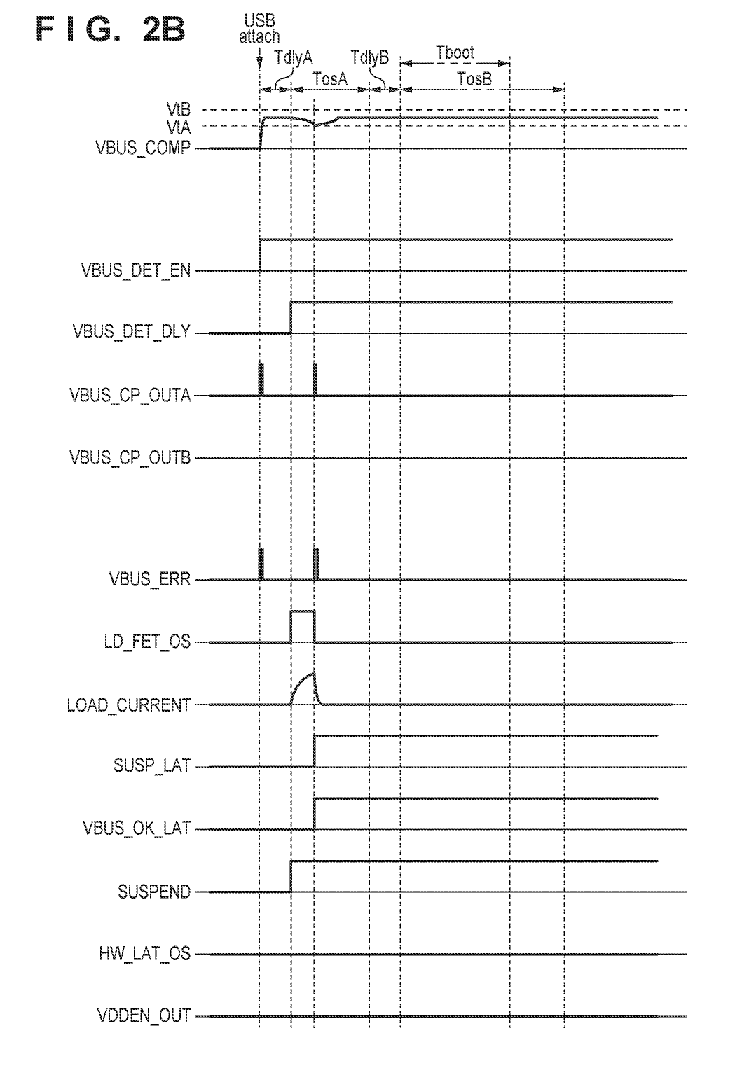

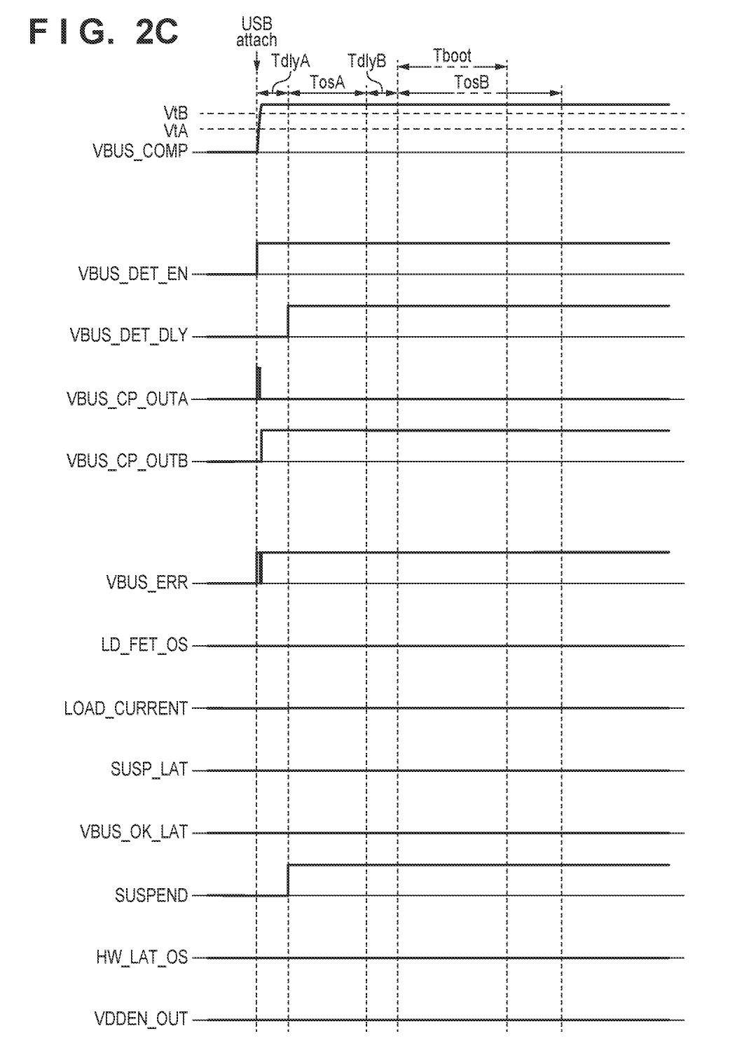

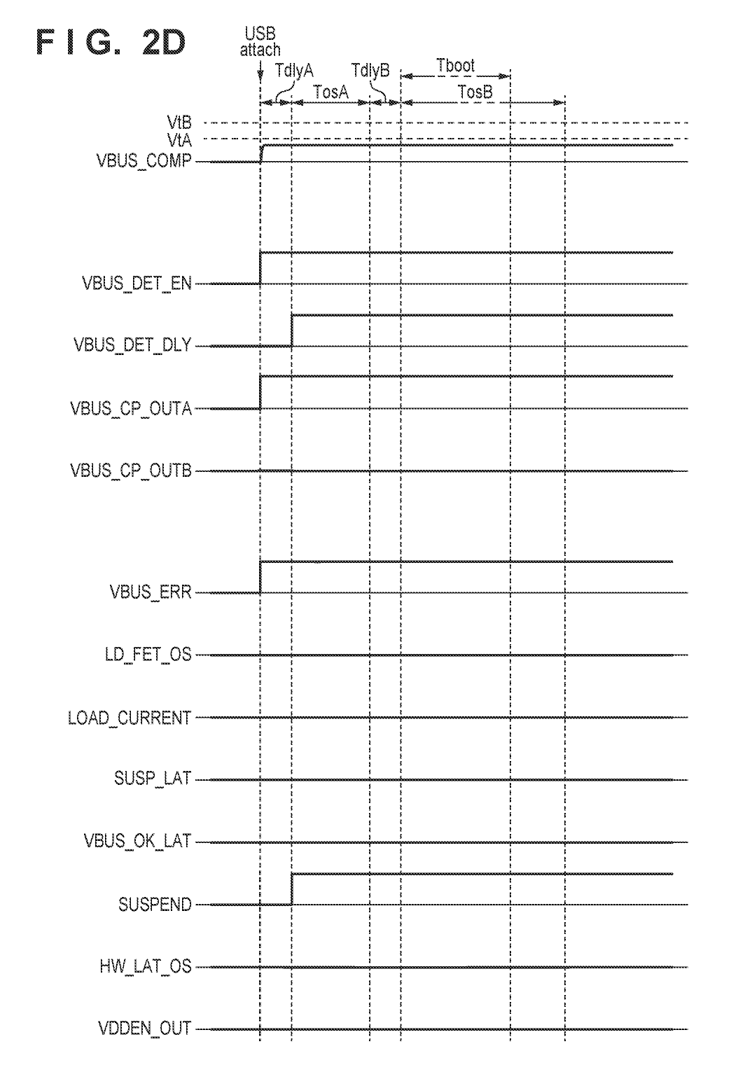

The timings of individual signals when generating the activation signal of the electronic device 301 by conducting the VBUS load test will be explained below with reference to timing charts shown in FIGS. 2A, 2B, 2C, and 2D. Note that in these timing charts of FIGS. 2A, 2B, 2C, and 2D, the signal names are the same as those explained with reference to FIGS. 1A, 1B, 3A, and 3B.

FIG. 2A is a timing chart when it is determined that the result of the VBUS load test is successful. When the VBUS voltage from the USB connector 380 is supplied to the power source control unit 303 at the timing of USB attach, the VBUS_DET_EN signal transits from L to H, and the voltage of the VBUS_COMP signal stabilizes with a delay of the ON time of the Pch MOSFET 334. When the voltage of the VBUS_COMP signal is lower than the reference voltage VtA 344, the VBUS_CP_OUTA signal is H, the VBUS_ERR signal is H, but the SUSPEND signal is L during the period of TdlyA (step S102). That is, the SUSPEND signal is masked during the period of TdlyA.

When the VBUS_DET_DLY signal transits from L to H after the elapse of TdlyA, the LD_FET_OS signal changes to H during the period of TosA, and the VBUS load test is conducted. The SUSPEND signal is H while the LD_FET_OS signal is H (during the period of the VBUS load test). When the LD_FET_OS signal transits from L to H, the gate voltage of the Nch MOSFET 337 gradually rises, and LOAD_CURRENT also gradually rises. After the elapse of TosA, the LD_FET_OS signal transits from H to L, and the SUSPEND signal changes to L (step S118). When the LD_FET_OS signal transits from H to L, the gate voltage of the Nch MOSFET 337 rapidly drops, and LOAD_CURRENT also rapidly drops.

When the LD_FET_OS signal transits from H to L, VBUS_OK_LAT is latched to H. After the elapse of TdlyB since VBUS_OK_LAT transits from L to H, the HW_LAT_OS signal changes to H for only the period of TosB. In the period of TosB during which the HW_LAT_OS signal outputs H, the CPU 304 activates the hardware and software in a Tboot time, and outputs H to the VDDEN_OUT signal. After the elapse of TosB, the HW_LAT_OS signal transits from H to L.

FIG. 2B is a timing chart when the state in which the VBUS_COMP voltage falls within the predetermined voltage range between VtA (inclusive) and VtB (inclusive) cannot be maintained in the VBUS load test, that is, when the result of the VBUS load test is unsuccessful.

When the VBUS voltage from the USB connector 380 is supplied to the power source control unit 303 at the timing of USB attach, the VBUS_DET_EN signal transits from L to H. The voltage of the VBUS_COMP signal stabilizes with a delay of the ON time of the Pch MOSFET 334. When the voltage of the VBUS_COMP signal is lower than the reference voltage VtA 344, the VBUS_CP_OUTA signal is H, the VBUS_ERR signal is H, but the SUSPEND signal is L during the period of TdlyA. That is, the SUSPEND signal is masked during the period of TdlyA.

After the elapse of TdlyA, the VBUS_DET_DLY signal transits from L to H, and the LD_FET_OS signal changes to H. While the LD_FET_OS signal is H, the SUSPEND signal is H. When the LD_FET_OS signal transits from L to H, the gate voltage of the Nch MOSFET 337 gradually rises, and LOAD_CURRENT also gradually rises.

If the VBUS voltage drops and the voltage of the VBUS_COMP signal becomes lower than the reference voltage VtA 344 during the period of the VBUS load test, that is, before the elapse of TosA, the VBUS_CP_OUTA signal changes to H. This means a failure of the VBUS load test. When the VBUS_CP_OUTA signal changes to H, the VBUS_ERR signal transits from L to H, and the SUSP_LAT signal is latched to H. While the SUSP_LAT signal is H, the LD_FET_OS signal and HW_LAT_OS signal are L, and the SUSPEND signal is H. When the LD_FET_OS signal transits from H to L, the gate voltage of the Nch MOSFET 337 rapidly drops, and LOAD_CURRENT also rapidly reduces. When the LD_FET_OS signal transits from H to L, the VBUS_OK_LAT signal changes to H, but the HW_LAT_OS signal remains L, so the CPU 304 does not activate the hardware and software.

FIG. 2C is a timing chart of the individual signals when it is determined that the VBUS_COMP voltage is higher than VtB before the start of the VBUS load test (NO in step S103).

When the VBUS voltage is supplied from the USB connector 380 at the timing of USB attach, the VBUS_DET_EN signal transits from L to H, and the voltage of the VBUS_COMP signal stabilizes with a delay of the ON time of the Pch MOSFET 334. When the voltage of the VBUS_COMP signal is lower than the reference voltage VtA 344, the VBUS_CP_OUTA signal changes to H, and the VBUS_ERR signal changes to H. Also, when the voltage of the VBUS_COMP signal is higher than the reference voltage VtB 346, the VBUS_CP_OUTA signal changes to H, and the VBUS_ERR signal changes to H.

Even when the VBUS_ERR signal is H, the SUSPEND signal is masked during the period of TdlyA, so the SUSPEND signal is L. After the elapse of TdlyA, however, the SUSPEND signal changes to H and maintains H. Also, while the VBUS_ERR signal is H, the LD_FET_OS signal remains L, so the VBUS load test is not started. As a consequence, the HW_LAT_OS signal remains L, and the CPU 304 does not activate the hardware and software.

FIG. 2D is a timing chart of the individual signals when it is determined that the VBUS_COMP voltage is lower than VtA before the VBUS load test is started (NO in step S103). Similar to FIG. 2C, the VBUS load test is not started because H of the VBUS_ERR signal is maintained even after the elapse of the period of TdlyA in this case as well. Consequently, the HW_LAT_OS signal maintains L, and the CPU 304 does not activate the hardware and software.

In the first embodiment as described above, the electronic device 301 sets the current consumption of the VBUS line of the charging IC 302 in the suspended state in accordance with the connection of the power supply apparatus 401, thereby conducting the VBUS load test. The electronic device 301 determines the power supply capability of the power supply apparatus 401 by the VBUS load test, and the CPU 304 generates an activation signal in accordance with the result of the determination. When conducting the VBUS load test, the electronic device 301 sets the current consumption of the VBUS line of the charging IC 302 in the suspended state. In the VBUS load test, therefore, almost no current is generated except the load testing current. Accordingly, the electronic device 301 can accurately determine the power supply capability of the power supply apparatus 401. Also, the electronic device 301 can activate the hardware and software after ensuring power required for the electronic device 301 by determining the power supply capability of the power supply apparatus 401. Therefore, the activated electronic device 301 can reliably perform connected device detection, the enumeration process with the power supply apparatus 401, battery authentication with the battery pack 320, power reception from the power supply apparatus 401, charging of the battery pack 320, and the like.

### Second Embodiment

In the first embodiment, the electronic device 301 starts the VBUS load test by setting the current consumption of the VBUS line in the suspended state under the condition that the power supply apparatus 401 is connected, and controls the generation of an activation signal of the electronic device 301 based on the result of the test. In the second embodiment, an example in which the VBUS load test is started under the condition that a power supply apparatus 401 and a battery pack 320 are connected to the electronic device 301.

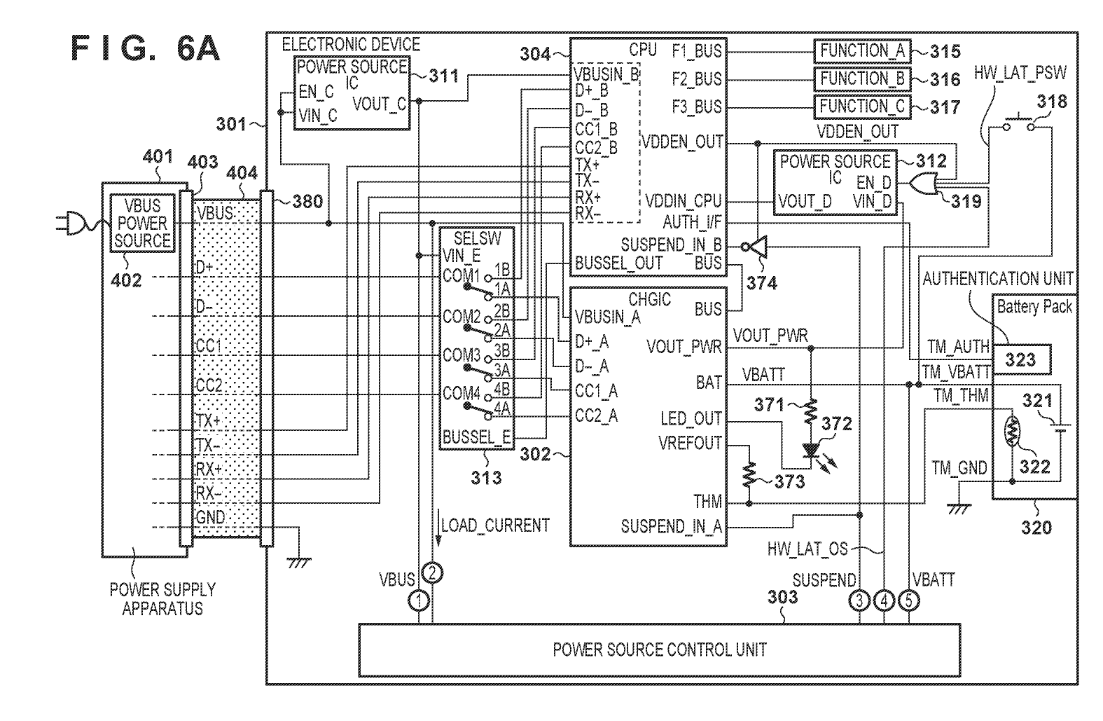

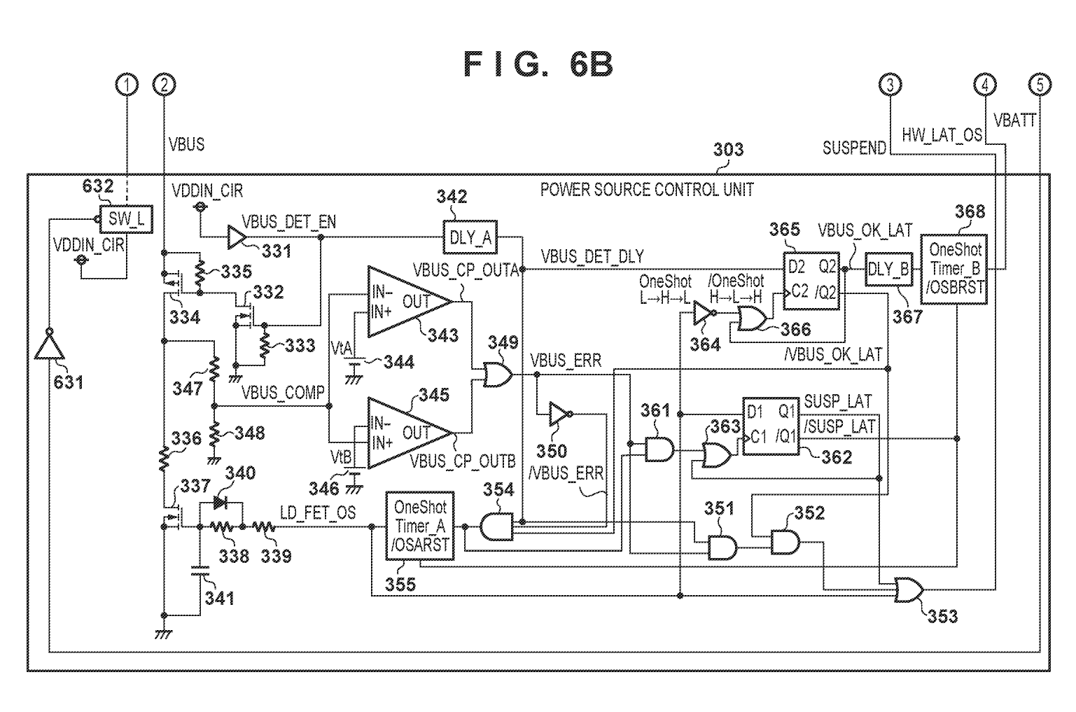

FIG. 6A is a block diagram for explaining an exemplary arrangement of the electronic device 301 according to the second embodiment. FIG. 6B is a block diagram for explaining an exemplary arrangement of a power source control unit 303 according to the second embodiment. Note that these block diagrams of FIGS. 6A and 6B do not show power source connections to constituent elements unnecessary for the explanation of the second embodiment, and input and output capacitors of each constituent element. Note also that a detailed explanation of constituent elements and operations unnecessary for the explanation of the second embodiment will be omitted.

Referring to FIG. 6A, the battery voltage (VBATT voltage) of the battery pack 320 is supplied to the power source control unit 303. Also, in the power source control unit 303 as shown in FIG. 6B, an inverter 631 and SW L 632 are added to the power source control unit 303 shown in FIG. 3B. Power is supplied from VOUT_C of a power source IC 311 to the power source control unit 303 via the SW L 632 and VDDIN_CIR. The SW L 632 is an element, such as a PNP transistor or Pch MOSFET, which is electrically connected when turned on, and increases the impedance when turned off. The inverter 631 detects the VBATT voltage of the battery pack 320, inverts the logic, converts the voltage level, and outputs the voltage to a control input for turning on/off the SW L 632. Note that it is also possible to divide the VBATT voltage and inputs the divided voltage to the inverter 631.

The SW L 632 is turned off when the output from the inverter 631 is H, and turned on when the output from the inverter 631 is L. Accordingly, power is supplied to VDDIN_CIR of the power source control unit 303 when both the VBUS voltage of the power supply apparatus 401 and the VBATT voltage of the battery pack 320 are supplied. Also, supplying power to VDDIN_CIR is stopped when the supply of one of the VBUS voltage of the power supply apparatus 401 and the VBATT voltage of the VBATT voltage of the battery pack 320 is stopped.

When supplying power to VDDIN_CIR of the power source control unit 303 is started, the logic of each circuit of the power source control unit 303 is initialized and the function of the circuit is negated, as in the first embodiment. When supplying power to VDDIN_CIR is terminated, the function of each circuit of the power source control unit 303 is negated, as in the first embodiment. An explanation of the transition state of each circuit unnecessary for the explanation of the second embodiment will be omitted.

When viewed from a CPU 304 and a charging IC 302, the power source control unit 303 of the second embodiment operates in the same manner as the power source control unit 303 of the first embodiment. However, although the power source control unit 303 of the first embodiment starts operating when the power supply apparatus 401 is connected, the power source control unit 303 of the second embodiment starts operating when the power supply apparatus 401 and battery pack 320 are connected. After the operation is started, the operation of the power source control unit 303 is the same such as that of the first embodiment.

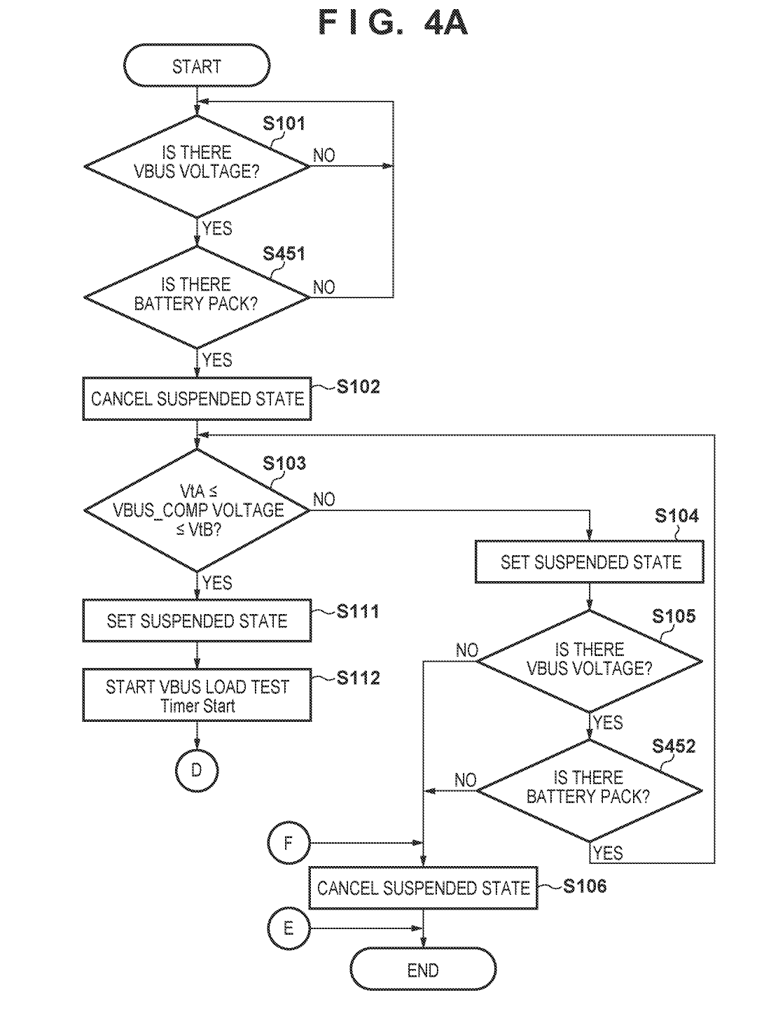

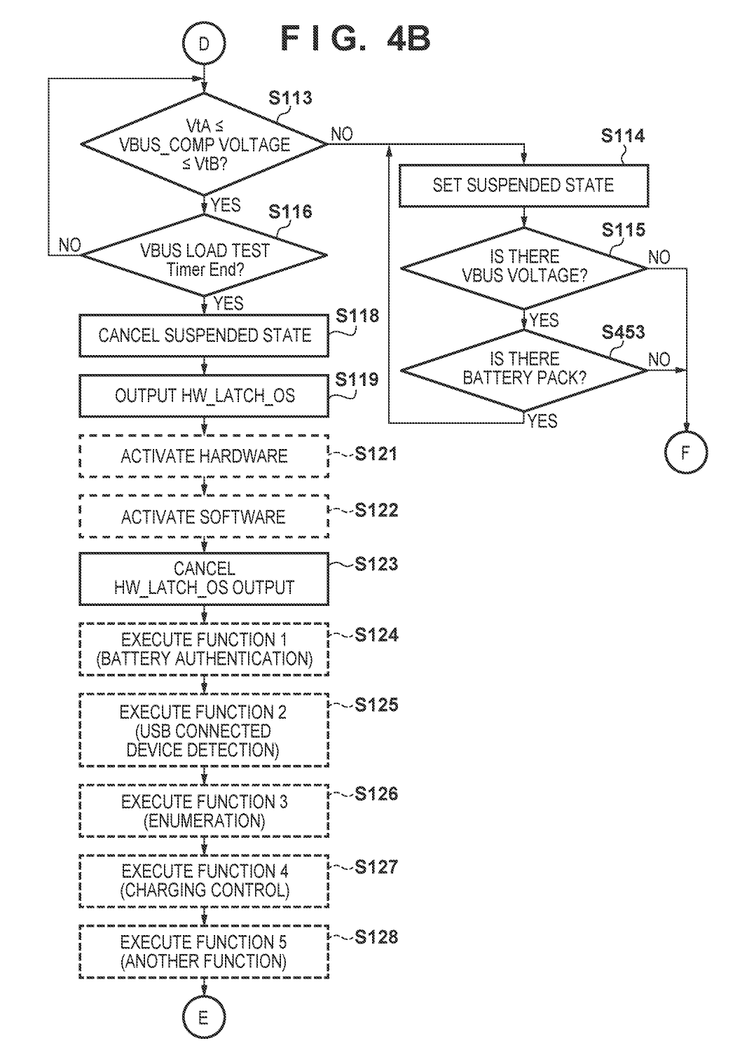

Next, an exemplary procedure of generating an activation signal of the electronic device 301 by performing a VBUS load test will be explained with reference to flowcharts shown in FIGS. 4A and 4B. Processes shown in the flowcharts of FIGS. 4A and 4B are processes to be performed by the power source control unit 303, and processes to be performed by units other than the power source control unit 303 are indicated by the broken lines. In FIGS. 4A and 4B, processes are the same as those of the first embodiment (see FIGS. 1A and 1B) except steps S451, S452, and S453. Therefore, portions different from the first embodiment will be explained below.

In the power source control unit 303, SW L is turned on by the VBATT voltage of the battery pack 320, and the VBUS voltage of the power supply apparatus 401 (the output from the power source IC 311) is supplied. That is, when both the VBUS voltage and the VBATT voltage of the battery pack 320 are supplied (YES in steps S101 and S451), the power source control unit 303 changes a SUSPEND signal to L for at least the period of TdlyA (step S102).

Also, if it is determined in step S103 that a VBUS_COMP voltage falls outside a predetermined voltage range between VtA (inclusive) and VtB (inclusive), the power source control unit 303 changes the SUSPEND signal to H (step S104). Then, the power source control unit 303 repeats the process of step S103 while both the VBUS voltage and VBATT voltage are supplied (YES in both steps S105 and S452). If the supply of at least one of the VBUS voltage and VBATT voltage is stopped, the power source control unit 303 cancels the suspended state of the charging IC 302 (step S106) by outputting L to the SUSPEND signal, and the flowcharts of FIGS. 4A and 4B are terminated (NO in step S105 or S452).

If it is determined in the period of the VBUS load test that the VBUS_COPM voltage falls outside the predetermined voltage range between VtA (inclusive) and VtB (inclusive) (NO in step S113), the power source control unit 303 maintains the SUSPEND signal output in step S111 at the level of H (step S114). This state is maintained while both the VBUS voltage and VBATT voltage are supplied (YES in both steps S115 and S453). If the supply of at least one of the VBUS voltage and VBATT voltage is stopped (NO in step S115 or S453), the power source control unit 303 executes the process of step S106 described above.

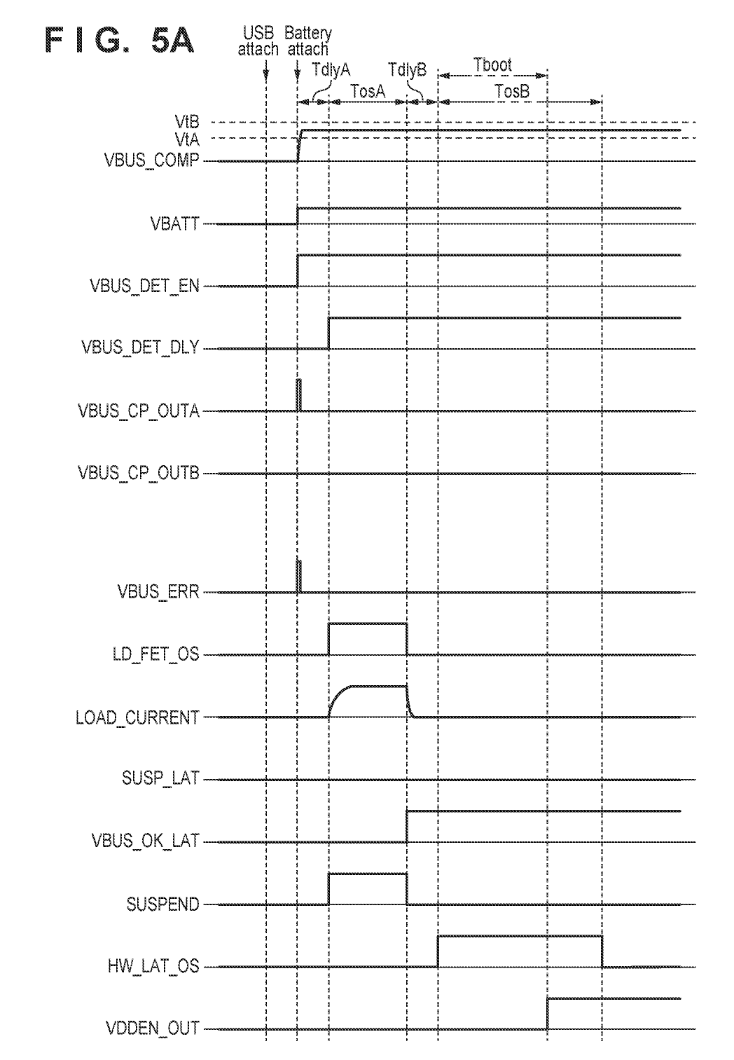

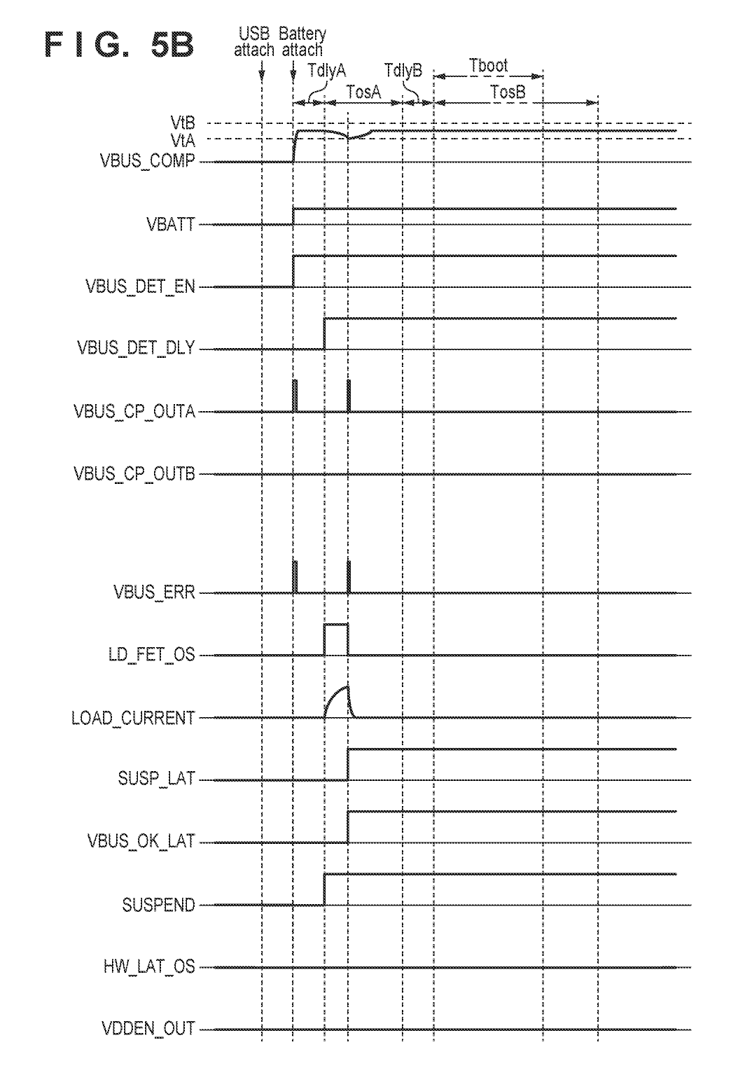

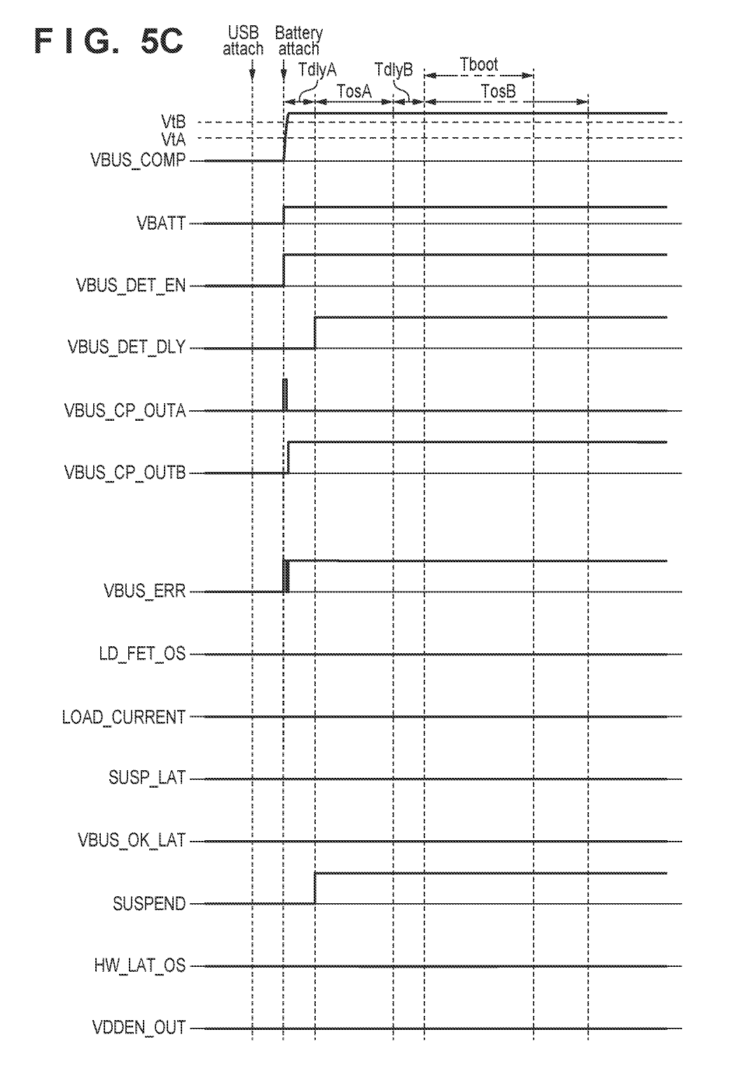

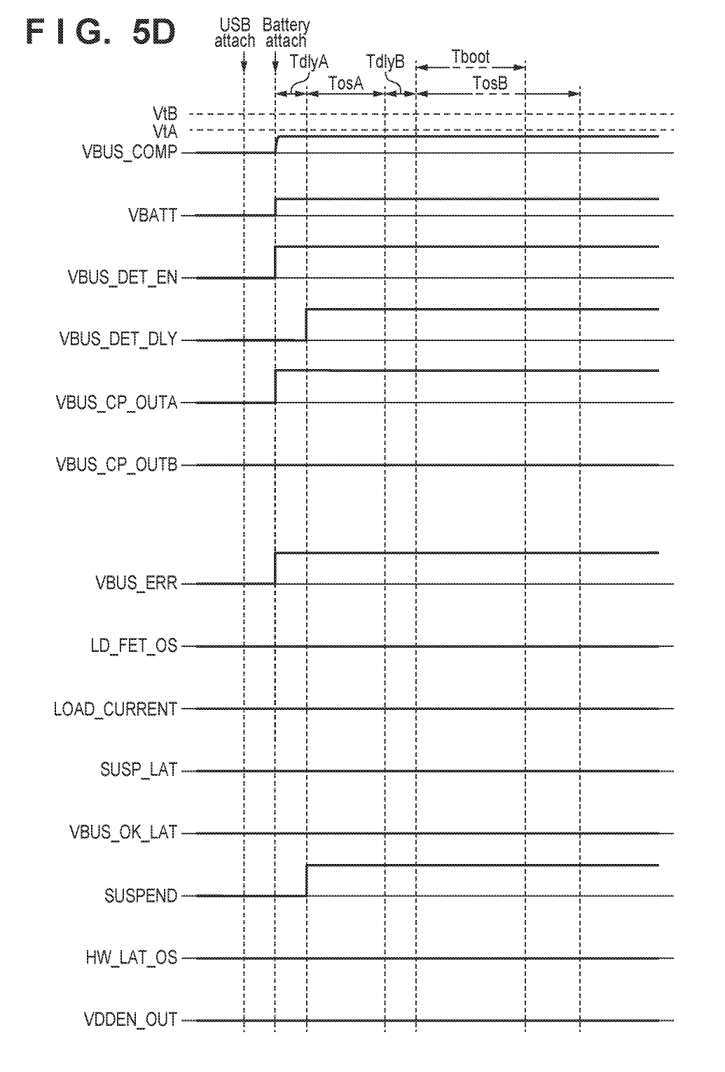

The timings of individual signals when generating an activation signal of the electronic device 301 by conducting the VBUS load test will be explained below with reference to timing charts shown in FIGS. 5A, 5B, 5C, and 5D. Note that in these timing charts of FIGS. 5A, 5B, 5C, and 5D, the signal names are the same as those explained with reference to FIGS. 4A, 4B, 6A, and 6B. In the timing charts of the second embodiment, the timing of the VBATT signal of the battery pack 320 is added to the timing charts (see FIGS. 2A and 2B) explained in the first embodiment.

FIG. 5A is a timing chart when it is determined that the result of the VBUS load test is successful. FIG. 5B is a timing chart when the state in which the VBUS_COMP voltage falls within the predetermined voltage range between VtA (inclusive) and VtB (inclusive) cannot be maintained in the VBUS load test, that is, when the result of the VBUS load test is unsuccessful. FIG. 5C is a timing chart of the individual signals when it is determined that the VBUS_COMP signal is VtB or more before the start of the VBUS load test (step S103). FIG. 5D is a timing chart of the individual signals when it is determined that the VBUS_COMP signal is VtA or less before the start of the VBUS load test (step S103).

In each of FIGS. 5A, 5B, 5C, and 5D, even when the VBUS voltage is supplied from a USB connector 380 at the timing of USB attach, the battery pack 320 is unconnected, so a VBUS_DET_EN signal remains L. When the battery pack 320 is connected at the timing of Battery attach, both the VBUS voltage and VBATT voltage are supplied, and the power source control unit 303 starts the operation after step S102. Operations after that in the timing charts shown in FIGS. 5A, 5B, 5C, and 5D are the same as those of the first embodiment (FIGS. 2A, 2B, 2C, and 2D).

In the second embodiment as described above, when the power supply apparatus 401 and battery pack 320 are connected, the electronic device 301 conducts the VBUS load test by suspending the current consumption of the VBUS line of the charging IC 302. The electronic device 301 determines the power supply capability of the power supply apparatus 401 by the VBUS load test, and generates an activation signal of the CPU 304 in accordance with the result of the determination. Accordingly, the electronic device 301 of the second embodiment can achieve the same effect such as that of the first embodiment.

### Third Embodiment

In the third embodiment, a VBUS load test of a power supply apparatus 401 is started when the power supply apparatus 401 and a battery pack 320 are connected to an electronic device 301, as in the second embodiment. In the third embodiment, however, the load testing current of the VBUS load test for determining the power supply capability of the power supply apparatus 401 is changed in accordance with the supply voltage from the battery pack 320. When the voltage (VBATT) supplied from the battery pack 320 is high, a CPU 304 can execute necessary processes by power supplied from the battery pack 320. Therefore, a power source control unit 303 of the third embodiment generates an activation signal without performing the VBUS load test of the power supply apparatus 401 (or by performing the VBUS load test with load testing current=0).

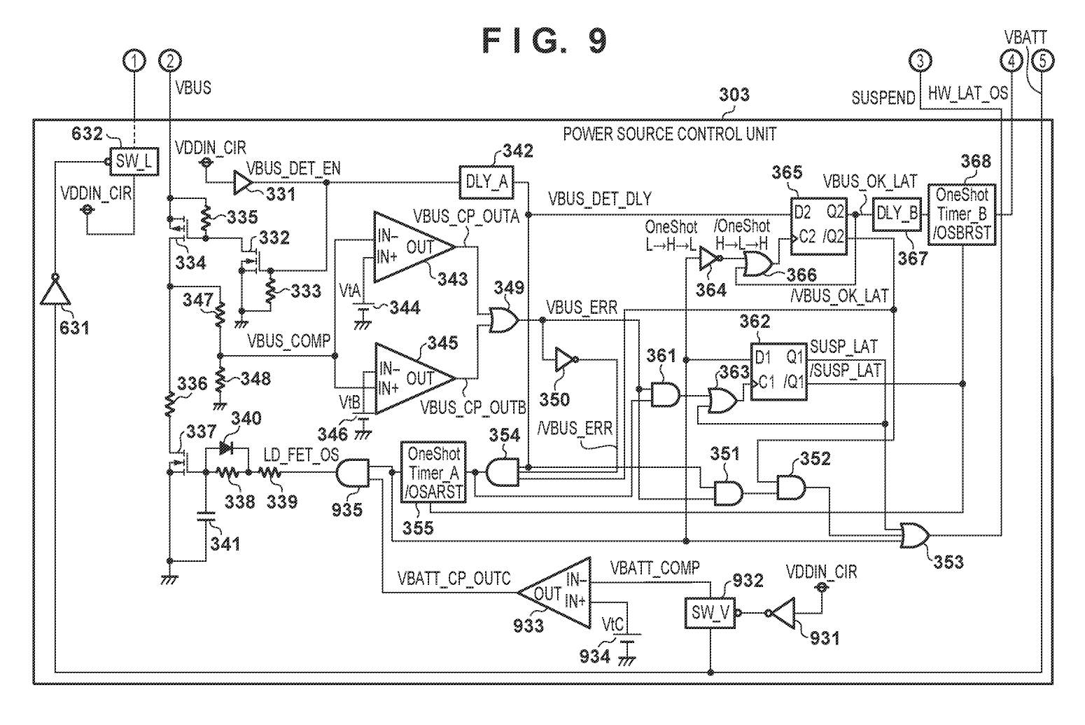

FIG. 9 is a block diagram for explaining an exemplary arrangement of the power source control unit 303 according to the third embodiment. Constituent elements of the electronic device 301 according to the third embodiment are the same as those of the second embodiment (see FIG. 6A) except the power source control unit 303. This block diagram of FIG. 9 does not show power source connections to constituent elements unnecessary for the explanation of the third embodiment and input and output capacitors of each constituent element. Also, a detailed explanation of constituent elements and operations unnecessary for the explanation of the third embodiment will be omitted.

The power source control unit 303 of the third embodiment is obtained by adding an inverter 931, an SW_V 932, a comparator 933, a reference voltage VtC 934, and an AND 935 to the power source control unit 303 explained in the second embodiment (see FIG. 6B). The inverter 931 inverts the logic of VDDIN_CIR of the power source control unit 303, and supplies the output to the control input of the SW_V 932. The SW_V 932 is turned off when the output from the inverter 931 is H, and turned on when the output from the inverter 931 is L. When the SW_V 932 is ON, the VBATT voltage of the battery pack 320 is supplied to the VIN− input of the comparator 933 via the SW_V 932. It is also possible to divide the VBATT voltage to be supplied to the SW_V 932, and supply the divided voltage to the VIN− input of the comparator 933. The SW_V 932 is an element, such as a PNP transistor or Pch MOSFET, which is electrically connected when turned on and increases the impedance when turned off. The output (VBATT_COMP) of the SW_V 932 is supplied to the VIN− input of the comparator 933.

The reference voltage VtC 934 is supplied to the VIN+ input of the comparator 933. In the third embodiment, the value of the reference voltage VtC 934 is set at a value satisfying the VBATT voltage of the battery pack 320 capable of turning on a power source IC 312 of the electronic device 301 and activating hardware including the CPU 304 of the electronic device 301 and software. The comparator 933 compares the VIN+ input and VIN− input, outputs H when the VIN+ input signal is larger (when VBATT_COMP>VtC), and outputs L in other cases. The output (VBATT_CP_OUTC) of the comparator 933 is connected to the input of the AND 935.

In the third embodiment, both the output signal from a one-shot timer 355 and the VBATT_CP_OUTC signal are input to the AND 935, and the output of the AND 935 is an LD_FET_OS signal. In the period of TosA, the output from the one-shot timer 355 is H. In addition, when the VBATT voltage is equal to or lower than the reference voltage VtC 934 (when the output from the comparator 933 is H), the LD_FET_OS signal as an output signal from the AND 935 is H. On the other hand, even when the output from the one-shot timer 355 is H in the period of TosA, if the VBATT voltage is higher than the reference voltage VtC 934 (if the output from the comparator 933 is L), the LD_FET_OS signal as an output signal from the AND 935 is L.

When the LD_FET_OS signal is H, an Nch MOSFET 337 is turned on, and a load testing current (LOAD_CURRENT) is generated. When the LD_FET_OS signal is L, the Nch MOSFET 337 is turned off, and no LOAD_CURRENT is generated. In the third embodiment, generation and non-generation of LOAD_CURRENT in the VBUS load test are switched in accordance with the VBATT voltage of the battery pack 320. That is, if the VBATT voltage of the battery pack 320 is not the voltage capable of activating the hardware including the CPU 304 of the electronic device 301 and the software, the electronic device 303 generates LOAD_CURRENT and executes the VBUS load test. On the other hand, if the VBATT voltage of the battery pack 320 is the voltage capable of activating the hardware including the CPU 304 of the electronic device 301 and the software, the power source control unit 303 does not generate LOAD_CURRENT, and generates an activation signal HW_LAT_OS.

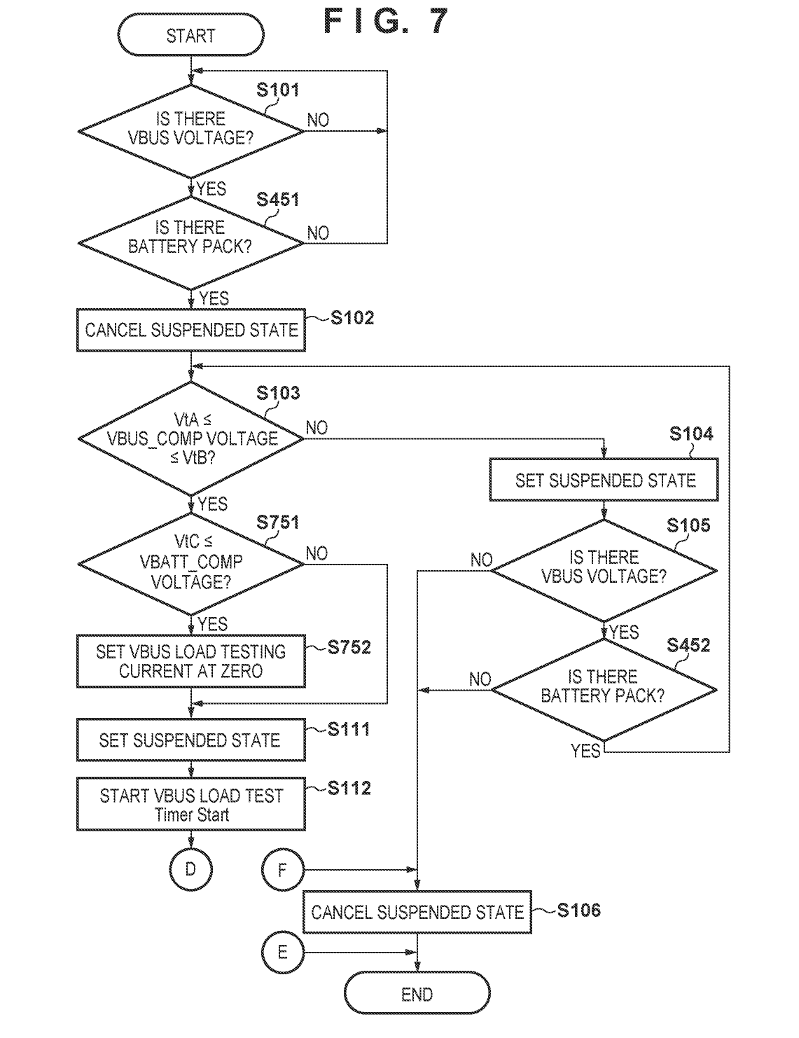

An exemplary procedure of generating an activation signal of the electronic device 301 by conducting the VBUS load test will be explained below with reference to a flowchart shown in FIG. 7. The power source control unit 303 performs processes shown in the flowchart of FIG. 7, and the broken lines indicate processes to be performed by units other than the power source control unit 303. In this flowchart of FIG. 7, processes as the same as those of the second embodiment (see FIG. 4A) except steps S751 and S752. Also, processes performed after step S112 are the same such as those of the second embodiment (see FIG. 4B). Processes in steps S751 and S752 will mainly be explained below.

If it is determined in step S103 that the VBUS_COMP voltage falls within a predetermined voltage range between VtA (inclusive) and VtB (inclusive), the power source control unit 303 determines whether the VBATT_COMP voltage (battery voltage) is VtC or more (step S751). If the VBATT_COMP voltage is VtC or more, the power source control unit 303 sets the value of the load testing current at 0 (step S752). In the block diagram shown in FIG. 9, the output (VBATT OP OUTC) of the comparator 933 changes to L, and the LD_FET_OS signal maintains L even when the one-shot timer 355 outputs H during the period of TosA. Consequently, OFF of the Nch MOSFET 337 is maintained, so no load testing current flows.

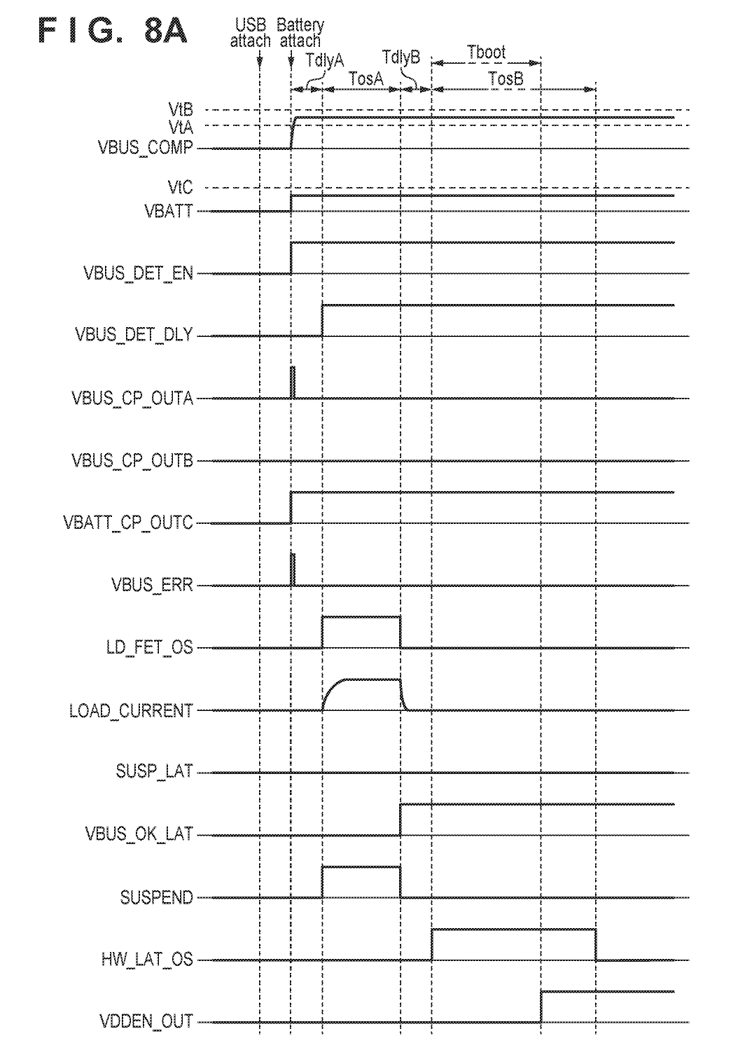

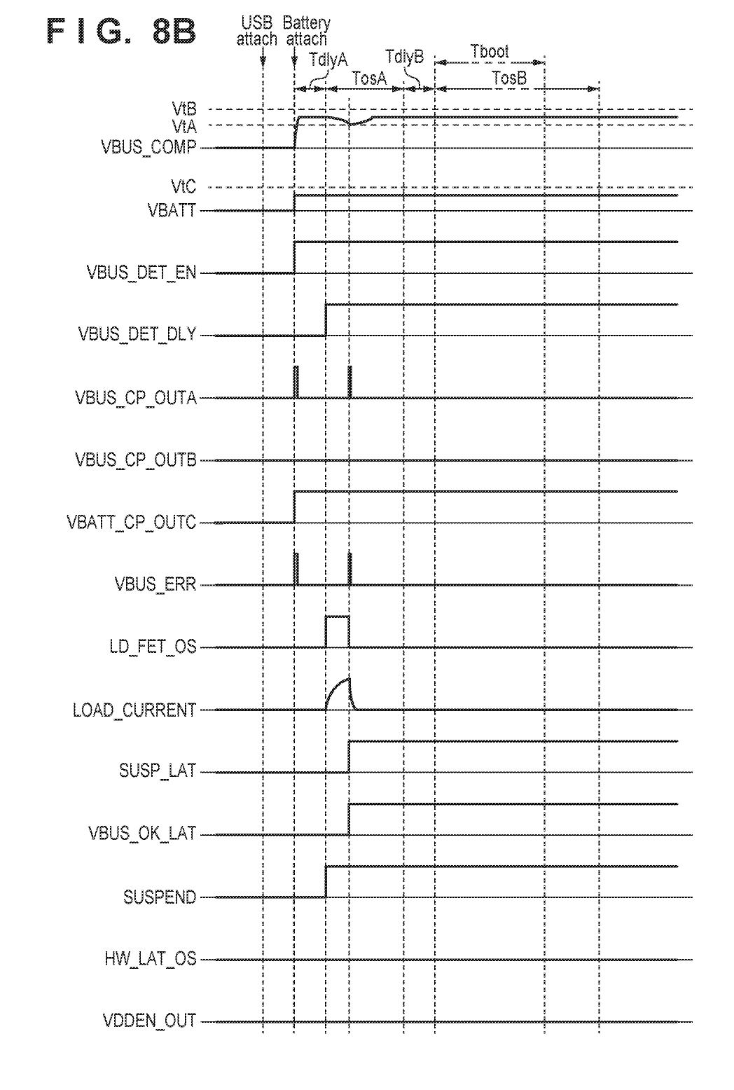

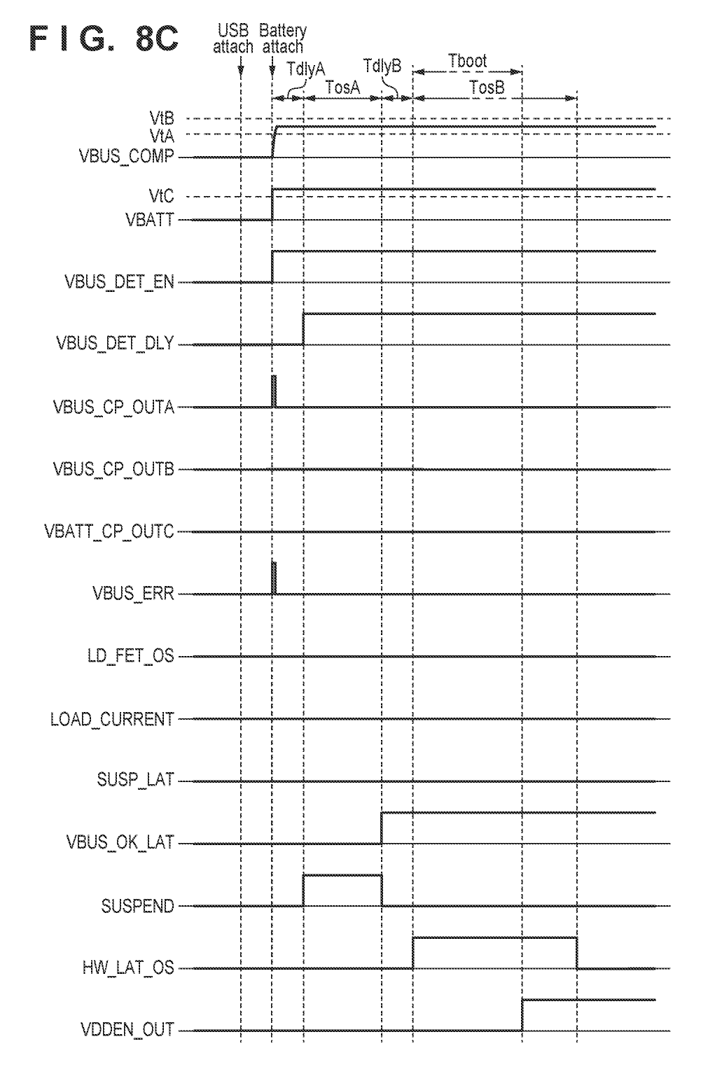

Next, the timings of individual signals when generating an activation signal of the electronic device 301 by conducting the VBUS load test will be explained with reference to timing charts shown in FIGS. 8A to 8C. In FIGS. 8A, 8B, and 8C, examples in which the electronic device 301 is connected to the power supply apparatus 401 and battery pack 320 will be explained. Note that in these timing charts of FIGS. 8A to 8C, the signal names are the same as those explained in the abovementioned embodiments. In the timing charts of the third embodiment, the timing of the VBATT_CP_OUTC signal as an output signal from the comparator 933 is added to the signals shown in the timing charts of the second embodiment (see FIGS. 5A, 5B, 5C, and 5D).

FIG. 8A is a timing chart when a VBUS load test of generating LOAD_CURRENT is conducted and it is determined that the result of this VBUS load test is successful. Since the VBATT_COMP voltage is less than VtC, the VBATT COP OUTC signal changes to H, and the VBUS load test of generating the load testing current (LOAD_CURRENT) is conducted. During the VBUS load test, the VBUS_COMP voltage falls within the predetermined voltage range between VtA (inclusive) and VtB (inclusive). Therefore, it is determined that the result of the VBUS load test is successful, so the activation signal (HW_LAT_OS) is H during the period of TosB. The rest of the operation is the same such as that of the operation shown in FIG. 5A.

FIG. 8B is a timing chart when the VBUS load test of generating LOAD_CURRENT is conducted and it is determined that the result of the VBUS load test is unsuccessful. Since the VBATT_COMP voltage is less than VtC, the VBATT_CP_OUTC signal changes to H, and the VBUS load test of generating the load testing current (LOAD_CURRENT) is conducted. During the VBUS load test, the VBUS_COMP voltage falls outside the predetermined voltage range between VtA (inclusive) and VtB (inclusive). Accordingly, it is determined that the result of the VBUS load test is unsuccessful, so the activation signal (HW_LAT_OS) does not change to H. The rest of the operation is the same such as that of the operation shown in FIG. 5B.

Referring to FIG. 8C, the VBATT_COMP voltage is VtC or more, so the VBATT_CP_OUTC signal remains L, and a VBUS load test of generating no load testing current is conducted. During the VBUS load test, the VBUS_COMP voltage falls within the predetermined voltage range between VtA (inclusive) and VtB (inclusive). Therefore, it is determined that the result of the VBUS load test is successful, so the activation signal (HW_LAT_OS) is H during the period of TosB. The rest of the operation is the same as those of the operations shown in FIGS. 8A and 5A.

In the third embodiment as described above, the electronic device 301 checks the voltage of the battery pack 320 when the power supply apparatus 401 and battery pack 320 are connected. Then, in accordance with the check result of the voltage of the battery pack 320, the electronic device 301 changes the load testing current of the VBUS load test for determining the power supply capability of the power supply apparatus 401. Note that in the third embodiment, the load testing current is set at 0 when the voltage of the battery pack 320 is equal to or higher than a predetermined value. However, the present invention is not limited to this. For example, the load testing current need only be set at a value smaller than the load testing current of the VBUS load test which is conducted when the voltage of the battery pack 320 is less than a predetermined value.

In the above-described power source control, the electronic device 301 can activate hardware and software while assuring power necessary for the operation of the electronic device 301 by power from the power supply apparatus 401 or power of the battery pack 320. In addition to the effects of the first and second embodiments, therefore, it is possible to avoid a situation in which no activation signal is generated because the power supply capability of the power supply apparatus 401 is insufficient although power necessary for the operation of the electronic device 301 can be ensured by power of the battery pack 320.

### Fourth Embodiment

The first to third embodiments have been explained by taking the case in which the operation of the power source control unit 303 is controlled by hardware as an example. In the fourth embodiment, an example in which the operation of a power source control unit 303 is controlled by software by a CPU different from a CPU 304.

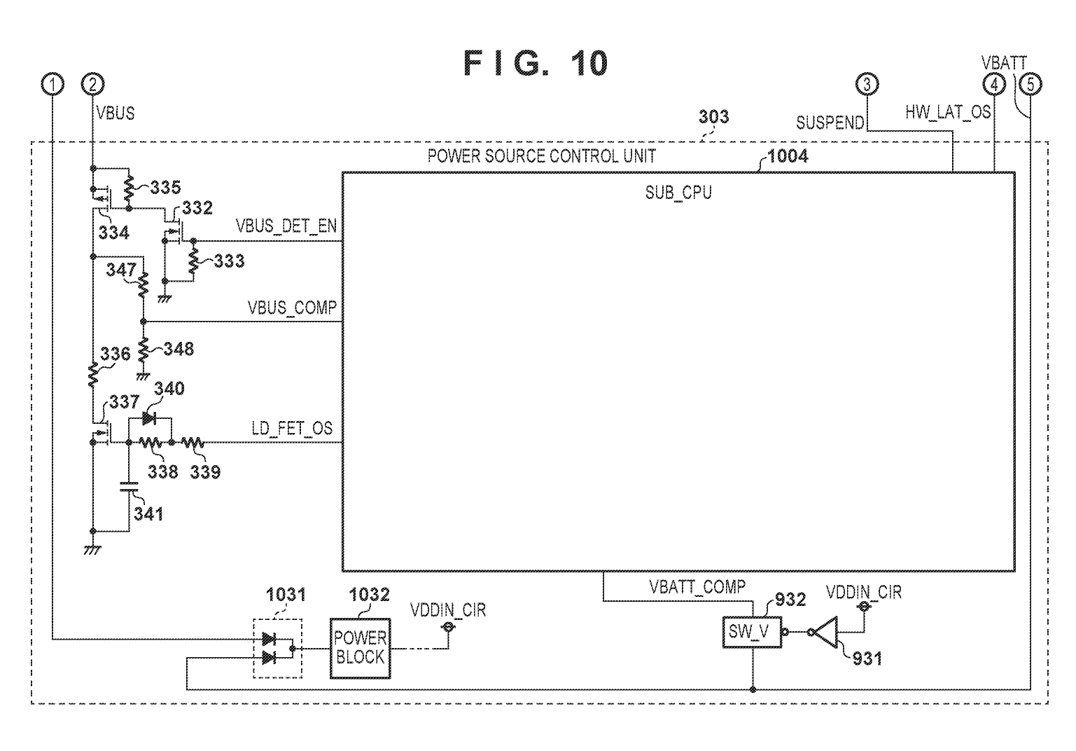

FIG. 10 is a block diagram for explaining an exemplary arrangement of the power source control unit 303 according to the fourth embodiment. Constituent elements of an electronic device 301 according to the fourth embodiment are the same as those of the second embodiment (see FIG. 6A) except the power source control unit 303. This block diagram of FIG. 10 does not show power source connections to constituent elements unnecessary for the explanation of the fourth embodiment. Also, a detailed explanation of constituent elements and operations unnecessary for the explanation of the fourth embodiment will be omitted.

Referring to FIG. 10, the power source control unit 303 is obtained by replacing a part of the power source control unit 303 explained in the third embodiment (see FIG. 9) with a SUB CPU 1004. The SUB CPU 1004 is a CPU which is different from the CPU 304, and installed to implement a software-controlled compatible operation of a part of the hardware control performed by the power source control unit 303 of the third embodiment. Furthermore, in the power source control unit 303 shown in FIG. 10, the inverter 631 and SW L 632 are deleted from the power source control unit 303 shown in FIG. 9, and a diode OR 1031 and a power source generator 1032 are added.

The power source generator 1032 receives a voltage obtained by ORing an output VOUT_C of a power source IC 311 and VBATT of a battery pack 320 by the diode OR 1031, and generates power to be supplied to VDDIN_CIR of the power source control unit 303. Power is supplied to VDDIN_CIR of the power source control unit 303 when one of a VBUS voltage of a power supply apparatus 401 and the VBATT voltage of the battery pack 320 is supplied. Supplying power to VDDIN_CIR is stopped when the supply of both the VBUS voltage of the power supply apparatus 401 and the VBATT voltage of the battery pack 320 is lost.

When supplying power to VDDIN_CIR is started, the logic of each circuit of the power source control unit 303 is initialized, and the function of the circuit is negated. When supplying power to VDDIN_CIR is terminated, the function of each circuit of the power source control unit 303 is negated. Also, the power source control unit 303 of each of the second and third embodiments starts operating when both the power supply apparatus 401 and battery pack 320 are connected. By contrast, the power source control unit 303 of the fourth embodiment starts operating when the power supply apparatus 401 or battery pack 320 is connected.

After starting the operation, the power source control unit 303 of the fourth embodiment operates in the same manner as the power source control unit 303 of the first, second, or third embodiment. That is, the electronic device 301 of the fourth embodiment can execute the processes explained in the first embodiment (see FIGS. 1A and 1B), the second embodiment (see FIGS. 4A and 4B), or the third embodiment (see FIG. 7). When viewed from the CPU 304 and a charging IC 302, the power source control unit 303 of the fourth embodiment and the power source control unit 303 of the first, second, or third embodiment operate in the same manner.

As described above, the fourth embodiment can achieve the same effects as those of the first to third embodiments even when the power source control unit 303 of the electronic device 301 performs software control instead of hardware control.

### Fifth Embodiment

The first to fourth embodiments have been explained by taking the case in which signal transmission between the charging IC 302 and the power source control unit 303 is performed by a parallel signal method as an example. However, the present invention is not limited to this. For example, signal transmission between the charging IC 302 and the power source control unit 303 may also be performed by using a serial signal. In this case, a versatile serial communication standard such as a two-wire or three-wire system can be used as the serial signal.

Also, the first to fourth embodiments have been explained by taking the case in which the charging IC 302 and power source control unit 303 are different units as an example. However, the present invention is not limited to this. For example, it is also possible to integrate the charging IC 302 and power source control unit 303 such that the charging IC 302 includes the function of the power source control unit 303. In this case, signals used between the charging IC 302 and power source control unit 303 as different units can be used as internal signals of the integrated charging IC 302 by properly performing logic synthesis.

Furthermore, the first to third embodiments have been explained by taking the case in which the power source control unit 303 of the electronic device 301 is configured by standard logic as an example. In addition, an example in which a part of the power source control unit 303 of the electronic device 301 is configured by the SUB CPU 1004 has been explained in the fourth embodiment. However, the present invention is not limited to these. For example, it is also possible to implement the power source control unit 303 by applying a reconfigurable IC such as a PLD (Programmable Logic Device). The power source control unit 303 can also be implemented by using a non-reconfigurable IC such as an ASIC (Application Specific Integrated Circuit).

### Sixth Embodiment

The various functions, processes, or methods explained in the first to fifth embodiments can also be implemented by a personal computer, microcomputer, CPU (Central Processing Unit), or microprocessor by using a program. In the sixth embodiment, a personal computer, microcomputer, CPU (Central Processing Unit), or microprocessor will be called “computer X”. Also, in the sixth embodiment, a program which controls computer X and implements the various functions, processes, or methods explained in the first to fifth embodiments will be called “program Y”.

The various functions, processes, or methods explained in the first to fifth embodiments are implemented by executing program Y by computer X. In this case, program Y is supplied to computer X via a computer-readable storage medium. This computer-readable storage medium according to the sixth embodiment includes at least one of a hard disk device, magnetic storage device, optical storage device, magnetooptical storage device, memory card, volatile memory, and nonvolatile memory. The computer-readable storage medium according to the sixth embodiment is a non-transitory storage medium.

While aspects of the present invention are described with reference to exemplary embodiments, it is to be understood that the aspects of the present invention are not limited to the exemplary embodiments. The scope of the following claims is to be accorded the broadest interpretation so as to encompass all modifications and equivalent structures.

This application claims priority from Japanese Patent Application No. 2017-028418, filed Feb. 17, 2017, which is hereby incorporated by reference herein in its entirety.

What is claimed is:

1. An electronic device comprising:
a load testing unit that conducts a load test between a power supply apparatus and the electronic device;
a first control unit that stops charging of a battery pack by power supplied from the power supply apparatus during a period in which the load test is conducted; and
a second control unit that stops outputting of an activation signal for activating the electronic device if a voltage supplied from the power supply apparatus to the electronic device falls outside a predetermined voltage range during the period in which the load test is conducted.

2. The electronic device according to claim 1, wherein the load testing unit conducts the load test when the power supply apparatus is connected to the electronic device and the battery pack is connected to the electronic device.

3. The electronic device according to claim 1, wherein the load testing unit draws a load testing current from the power supply apparatus and conducts the load test if an output voltage from the battery pack is less than a predetermined value, and conducts the load test without drawing the load testing current if the output voltage from the battery pack is not less than the predetermined value.

4. The electronic device according to claim 1, wherein the second control unit outputs the activation signal if the load test is complete while the voltage supplied from the power supply apparatus to the electronic device does not fall outside the predetermined voltage range.

5. The electronic device according to claim 1, further comprising a unit that performs an enumeration process complying with one of USB standards between the power supply apparatus and the electronic device if the activation signal is output.

6. The electronic device according to claim 5, wherein the enumeration process is performed by one of power supplied from the power supply apparatus and power supplied from the battery pack.

7. The electronic device according to claim 1, wherein if charging of the battery pack by power supplied from the power supply apparatus is stopped, a current from the power supply apparatus is restricted to a predetermined suspend current.

8. The electronic device according to claim 1, wherein the load testing unit starts the load test after a predetermined time has elapsed since the supply of power from the power supply apparatus to the electronic device is started.

9. A method comprising:
conducting a load test between a power supply apparatus and an electronic device;
stopping charging of a battery pack by power supplied from the power supply apparatus during a period in which the load test is conducted; and
stopping outputting of an activation signal for activating the electronic device if a voltage supplied from the power supply apparatus to the electronic device falls outside a predetermined voltage range during the period in which the load test is conducted.

10. A non-transitory storage medium that stores a program causing a computer to execute a method, the method comprising:
conducting a load test between a power supply apparatus and an electronic device;
stopping charging of a battery pack by power supplied from the power supply apparatus during a period in which the load test is conducted; and
stopping outputting of an activation signal for activating the electronic device if a voltage supplied from the power supply apparatus to the electronic device falls outside a predetermined voltage range during the period in which the load test is conducted.
